(19) United States
(12) Patent Application Publication
(10) Pub. No.: US 2023/0312853 A1
(43) Pub. Date: Oct. 5, 2023

(54) SURFACE MODIFICATION OF POLYMERIC MATERIALS

(71) Applicant: UNIVERSITY OF SOUTH FLORIDA, Tampa, FL (US)

(72) Inventors: Nurettin Sahiner, Tampa, FL (US); Ramesh S. Ayyala, Tampa, FL (US); Venkat Rama Bhethanabtla, Tampa, FL (US)

(21) Appl. No.: 18/174,724

(22) Filed: Feb. 27, 2023

Related U.S. Application Data
(60) Provisional application No. 63/480,847, filed on Jan. 20, 2023.
(60) Provisional application No. 63/314,297, filed on Feb. 25, 2022.

(51) Int. Cl. C08J 7/18

(52) U.S. Cl. CPC C08J 7/18; C08J 2333/12; C08J 2369/00

(57) ABSTRACT

The disclosure provides an article comprising a substrate having a surface including (i) a matrix of an optically transparent polymeric material having a first surface functionality, and (ii) at least one plasma-treated surface region comprising a portion of the surface, wherein each surface region comprises a second surface functionality, and wherein the first surface functionality and the second surface functionality are different The disclosure also provides a method for forming an article, the method comprising: (a) providing a substrate having a surface including an optically transparent polymeric material, (b) contacting the surface with a first plasma to create at least one plasma-treated surface region comprising a portion of the surface, each plasma-treated surface region having a first surface functionality, and (c) contacting each plasma-treated surface region with a second plasma to create a second surface functionality.

### CROSS-REFERENCES TO RELATED APPLICATIONS

This application claims priority to U.S. Pat. Application No. 63/314,297 filed Feb. 25, 2022, and U.S. Pat. Application No. 63/480,847 filed Jan. 20, 2023.

### STATEMENT REGARDING FEDERALLY SPONSORED RESEARCH

Not applicable.

### BACKGROUND OF THE INVENTION

### 1. Field of the Invention

This invention relates to surface modification by plasma treatment. More specifically, this invention relates to polymer surface modification by plasma treatment using air, oxygen or CF₄ gas.

### 2. Description of the Related Art

Microbial biofilms on medical implants are a major cause of hospital acquired infections and are very difficult to eradicate. Biofilms associated with implant infections are challenging to treat because they are often antibiotic-resistant, and the use of antibiotics alone is frequently ineffective for treating biofilm-related infections. Therefore, efficient methods of preventing biofilm formation are desirable. [See Sharma et al. Antimicrob Resist Infect Control, 8, 76 (2019).]

Implant-related infection is known as a catastrophic complication, and patients with severe infection often require revision surgery. On average, 2-5% of implants are estimated to be contaminated, and the additional cost associated with the management of each patient with implant-related infection (drug treatment and surgical revision) is estimated to be around 100,000 USD. [See De-la-Pinta et al., J Mater Sci: Mater Med., 30, 77 (2019).]

Microbial adhesion to the surface of medical implants and equipment starts with the initial attachment which depends on surface polarity, surface free energy, and wettability. Other factors such as roughness, hydrophobicity, and hydrophilicity can further affect the attachment of microbes to the surface. [See Wang et al. J. Orthopaedic Translation, 17, 42 (2019).]

What is needed therefore are reliable methods of tuning these surface properties in order to develop polymer surfaces that preclude initial microbial attachment.

### SUMMARY OF THE INVENTION

The present invention addresses the foregoing needs by providing polymer surfaces with tuned surface polarity, surface free energy, and wettability.

In one aspect, the disclosure provides an article comprising a substrate having a surface including (i) a matrix of a polymeric material having a first surface functionality, and (ii) at least one plasma-treated surface region comprising a portion of the surface, wherein each surface region comprises a second surface functionality, and wherein the first surface functionality and the second surface functionality are different.

In another aspect, the disclosure provides a method for forming an article, the method comprising: (a) providing a substrate having a surface including a polymeric material, (b) contacting the surface with a first plasma to create at least one plasma-treated surface region comprising a portion of the surface, each plasma-treated surface region having a first surface functionality, and (c) contacting each plasma-treated surface region with a second plasma to create a second surface functionality.

These and other features, aspects, and advantages of the present invention will become better understood upon consideration of the following detailed description, drawings, and appended claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 shows the contact angle values of Polycarbonate surfaces for a) 30W, b) 90W c) 150W and d) 250W treatments corresponding to different treatment times.

FIG. 2 shows the contact angle values of PMMA surfaces for a) 30W, b) 90W c) 150W and d) 250W treatments corresponding to different treatment times.

FIG. 3 shows the surface patterns with a) lines b) squares and c) triangular shapes with different pattern sizes.

FIG. 4 shows optical camera pictures of (a) polycarbonate (PC) and (b) polymethylmethacrylate (PMMA) for a drop of DI water and their contact angle (CA) values for (I) untreated and after 2 minutes treatment with (II) air, (III) O₂ and (IV) CF₄ gas plasmas.

FIG. 5 shows the change in CA values after PC surfaces are treated with different plasma gas having (a) a line pattern (b) a triangular pattern and (c) a square pattern template.

FIG. 6 shows the change in CA values after treated with different plasma gas under a) a line pattern (b) a triangular pattern and (c) a square pattern for PC surfaces with different pattern sizes.

FIG. 7 shows (a) an illustration of advancing, receding, and tilting angles and (b) optical camera pictures of untreated PC and PMMA surfaces with (I) 15 µL (II) 30 µL (III) 45 µL and (IV) 50 µL drops of DI water with 90° tilt angle.

FIG. 8 shows plots of sliding angle values of PC surfaces for different surface patterns and plasma gas treatment conditions.

FIG. 9 shows plots of sliding angle values of PMMA surfaces for different surface patterns and plasma gas treatment conditions.

FIG. 10 shows contact angle values of (a) PMMA and (b) Polycarbonate surfaces after treatment with (I) CF₄ plasma (II) Air plasma and (III) O₂ plasma against different pH rates.

FIG. 11 shows contact angle values of (a) PC and (b) PMMA surface after treatment with different plasmas against different NaCl concentrations.

FIG. 12 shows X-ray Photoelectron Spectroscopy (XPS) results of (a) PC and (b) PMMA surfaces after treatment with CF₄, Air and O₂ plasmas.

FIG. 13 shows the change in CA values of (a) PC and (b) PMMA surfaces upon sequential plasma treatment of CF₄, Air and O₂ plasma.

FIG. 14 shows photoluminescent properties of (a) PC and (b) PMMA surfaces after treatment with different plasmas and pyrene.

FIG. 15 shows the change in contact angle (CA) values under 2 minutes plasma treatment of (a) LDPE, (b) silicone at 2 minutes treatment time with air, CF₄, and O₂ plasma at varying power levels, and (c) the change in CA values of LDPE with CF₄ (90W), Air (150W), and O₂ (30W), and (d) silicone with CF₄ (250W), Air (150W), and O₂ (60W) at varying irradiation times. Arrows point out the average values of the optimum contact angles

FIG. 16 shows contact angle measurements LDPE and silicone under with optimum plasma parameters for different measuring liquids to determine the stability of surfaces under different environments such as (a) different pH values, (b) different NaCl concentrations, and (c) different BSA concentrations.

FIG. 17 shows the change in SFE of LDPE and silicone with time to determine the stability of the plasma treated samples for (a) right after treatment, and after storage in (b) air, (c) vacuum, and (d) water.

FIG. 18 shows SEM images of (a) LDPE and (b) silicone at different magnifications for untreated, CF₄ plasma treated, O₂ plasma treated, and air plasma treated samples.

FIG. 19 shows an AFM roughness analysis of LDPE for a) untreated, b) CF₄, c) O₂, and d) air plasma treated surface.

FIG. 20 shows an AFM roughness analysis of silicone for a) untreated, b) CF₄, c) O₂, and d) air plasma treated surface.

FIG. 21 shows an AFM 3D surface analysis of LDPE and silicone as (a) untreated, and after (b) CF₄, (c) O₂, and (d) air plasma treatments.

FIG. 22 shows FT-IR - ATR spectra of (a) LDPE and (b) silicone for untreated, air plasma treated, CF₄ plasma treated, and O₂ plasma treated samples.

FIG. 23 shows XPS survey scans of LDPE (a) untreated, and plasma gas treated with (b) CF₄, (c) O₂, and (d) air and silicone (e) untreated, and plasma gas treated with (f) CF₄, (g) O₂, and (h) air.

FIG. 24 shows contact angles as measured for (a) LDPE and (b) silicone for consecutive treatments with multiple plasma gases.

### DETAILED DESCRIPTION OF THE INVENTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The following discussion is presented to enable a person skilled in the art to make and use embodiments of the invention. Various modifications to the illustrated embodiments will be readily apparent to those skilled in the art, and the generic principles herein can be applied to other embodiments and applications without departing from embodiments of the invention. Thus, embodiments of the invention are not intended to be limited to embodiments shown and described, but are to be accorded the widest scope consistent with the principles and features disclosed herein. Skilled artisans will recognize the examples provided herein have many useful alternatives and fall within the scope of embodiments of the invention.

Polymeric materials are versatile with many applications, yet the inert nature of most polymers causes difficulties in their applications. Altering these polymers’ surface properties to change their chemistry and customize their interaction with their environments for the intended use is a challenge without altering their bulk properties. Exposing polymer surface to plasma to modify its surface chemistry is a typical advantageous strategy. This technique is used to modify the adhesion qualities of a wide range of polymers, either to increase their adhesive capabilities by rendering their surface more hydrophilic, or by decreasing their adhesive properties by making their surface more hydrophobic. The ability to modify the surface without changing the bulk characteristics of polymers is considered an advantageous technology for surface modification hence enabling the coating of a variety of materials.

For example, to determine whether a material can be used in biomedical applications, adhesion characteristics and the wetting nature, namely a hydrophilic or hydrophobic character, must be taken into account. An implant with a high degree of hydrophobicity, for instance, is more inert and less likely to promote blood coagulation than one made up of a hydrophilic material. Plasma treatment is a speedy procedure as compared to other treatment methods because it introduces new chemical groups into the surface layers of a polymer material, such as carboxylic, hydroxyl, amine, or aldehyde groups within a few seconds without using any wet chemistries. The plasma treatment procedure is reproducible and uses a minimal amount of energy and chemicals, hence no waste is generated. As no solvents are needed, the procedure is considered to be dry, clean, and environmentally friendly. Additional benefits of plasma processes are their simplicity, affordability, and high efficiency.

This is invention is about the plasma treatment of commercially available polymers such as low-density polyethylene (LDPE) and medical grade silicone (polydimethylsiloxane/PDMS) sheets, polycarbonate (PC), and polymethylmethacrylate (PMMA), polyvinyl chloride (PVC), polytetrafluoroethylene (PTFE), geomembranes and graphene sheets, films, plates and coatings and etc. The plasma gas treatment mainly consisted of functionalization/activation of the materials but is also coupled with a slight degree of etching that occurs during the treatment process depending on the applied power to generate plasma and exposure time. Different gases, e.g., carbon tetrafluoride (CF₄), oxygen (O₂), air, hydrogen (H₂), carbon dioxide (CO₂), and so on can be utilized for the changes in the surface properties of the polymeric materials. In the literature mainly these plasma gases are used for the surface modification of polymeric materials, metals surfaces, woods, and composite materials only once. As shown herein, the surface of the polymeric materials and composites can be treated with multiple successive gas plasma treatments up to 6 times to achieve desired surface functionality resulting in desired hydrophilicity (wettability) and/or hydrophobicity. Furthermore, the surface featured polymers e.g., heterogeneous surfaces by various shapes (porosities) of the samples can be treated multiple times with different plasma gas sequentially and multiple times to obtain desired properties. Moreover, using masks with different surface patterns such as lines, squares, circles, and triangles in various size ranges e.g., from a few hundred nanometers to a few hundred micrometers during plasma gas treatments of the polymer surface enables polymer surfaces with variable surface characteristics. This mask with different surface patterns is made up of thick (>0.5 mm) aluminum or steel plates. The single and/or multiple plasma gas treatments of polymeric surfaces in the presence of these plates enable the surface properties of polymeric materials with heterogeneous surface features e.g., some parts of the surface can be hydrophilic while some parts of the surfaces are hydrophobic depending on the nature of the polymer materials, and plasma gases and their order or applications. The surface properties such as water contact angle (CA), surface free energy (SFE), and contact angle hysteresis (CAH) of the polymeric materials changes depending on the polymers, polymer surface properties (homogeneous, heterogeneous or porous or nonporous) and applied gas plasma types and their order of application.

The surface plasma modification of medical implants can prevent infections and afford the extended time of use within the body. The surface plasma-modified tubing enables lesser friction reducing the energy cost of transportation of liquids (for example, water, solvents, and the like). The surface plasma-modified glasses of their polymeric coated surfaces can have additional properties including antibacterial, antiviral, antifogging, anti-biofouling, anti-static, self-cleaning, anti-reflective, UV protective, and the like.

Applications can include articles or items of manufacture such as biomedical implants, medical devices, glass window coatings (for example, commercial buildings, automobiles, homes, and the like), paint and surface coatings, polymeric tubing, hose, and polymeric sheets, textiles, packaging (for example, food, electronic, cargo, and the like), space technology, solar panels, eyewear such as goggles, sun glasses, vision glasses, contact lenses, corneal implants, and common surfaces (kitchen, flooring, and the like) such as in households, hospitals, and schools.

According to an aspect of the invention disclosed herein, an article can include a substrate. The substrate can have a surface. The substrate can include a matrix of a polymeric material. For example, the polymeric material can be selected from the group consisting of polyalkylenes, polysiloxanes, acrylates, polycarbonates, polyvinyl halides, fluoropolymers, and mixtures thereof. In another example, the polymeric material can be polyethylene, polydimethylsiloxane, polymethylmethacrylate, polycarbonate, polyvinyl chloride, or polytetrafluoroethylene. The polymeric material can be optically transparent. Additionally and alternatively, the polymeric material can be translucent or non-transparent.

The substrate can have a native surface functionality. The native surface functionality can be a portion of the polymeric material. The native surface functionality can include any functional group selected from the group of methyl, methylene, -CF2-, methyl ester, carbonyl, chloro, fluoro, alkylsiloxane, dimethylsiloxane —O—Si(CH₃)₂—O—), carbonate, or phenyl.

The substrate can further have at least one plasma-treated surface region comprising a portion of the surface. The surface can include a plurality of plasma-treated spaced apart surface regions. Each plasma-treated surface region includes a second surface functionality. The first surface functionality and the second surface functionality can be different.

According to an aspect of the disclosure herein, the surface can have a contact angle (CA) in a range of less than 150°, less than 120°, less than 100°, less than 90°, less than 60°, less than 50°, or less than 30°.

The surface can have a sliding angle. To determine the sliding angle, a droplet is placed on the surface, where the surface is initially in a horizontal position. The surface is tilted from horizontal to measure the sliding angle. The sliding angle is the angle at which a water droplet moves from an initial position on the horizontally positioned surface under the force of gravity. According to an aspect, the surface can have a sliding angle in a range of 30° to 120°, in a range of 30° to 100°, a range of 60° to 100°, or in a range of 80° to 120°. According to another aspect, the surface can have a sliding angle greater than 30°, greater than 60°, greater than 90°.

The surface can have a surface free energy (SFE) in a range of 10 mN/m to 65 mN/m as measured by the Owens-Wendt-Rabel and Kaelble method (See Example 1, 2). The surface free energy can be stable in storage conditions. For example, the article can be stored by immersion in a media selected from the group consisting of air, vacuum, or water. In such storage conditions, the SFE can remain within +/- 25% of the original value, +/- 15% of the original value, or +/- 5% of the original value, over time, such as for at least three days, at least four days, at least five days, or at least seven days.

The surface can have a surface roughness as measured by measuring an average of surface heights and depths across the surface. According to an aspect, the surface can have a surface roughness in a range of 16 nanometers (nm) to 34 nm.

According to an aspect, each plasma-treated surface region can have a shape selected from polygons, circles, ellipses, and ovals. Each surface region can have a largest dimension in a range of 1 micrometer to 10 millimeters, 10 micrometers to 1 millimeters, 100 micrometers to 1 millimeter, or 100 micrometers to 750 micrometers.

The plasma-treated surface regions can be arranged in a symmetrical array such that the shapes are spaced apart. The plasma-treated regions can have a surface functionality including at least one functional group selected from the group consisting of hydroxyl, carboxylic acid, carboxylate, peroxide, epoxide, oxide, carbonyl, ketone, ether, or ester, and the second surface functionality comprises at least one functional group selected from the group consisting of fluoride or fluorocarbon. The surface functionality arises from the plasma treatment.

According to an aspect, the article can be formed by a method including exposing the surface to plasma in multiple sequential steps. For example, the surface can be exposed to a plasma at least 4 times. 5 times, at least 6 times, at least 7 times, at least 8 times, at least 9 times, or at least 10 times.

In an example, the substrate having a surface including an optically transparent polymeric material can be contacted with a first plasma to create at least one plasma-treated surface region. The plasma-treated surface region can have a first surface functionality. After contacting each plasma-treated surface region with a second plasma, the surface can have second surface functionality.

The plasma-treated region can include at least a portion of the surface. For example, a mask can be placed over the surface before contacting the first plasma. The mask can include an array of spaced apart holes, where the holes can have a variety of shapes. The shapes can be polygons, circles, ellipses, or ovals.

The surface regions can be subjected to multiple plasma treatments in a sequence. The plasma treatment of the surface can include contacting the surface with the plasma, where the plasma is provided at a specified power for a specified time. For example, the sequence can include multiple treatments of the surface with one of the first plasma or the second plasma. The multiple treatments can be 2 treatments, 3 treatments, 4 treatments, up to 6 treatments, up to 10 treatments or up to 20 treatments.

In another example, the sequence can include alternating treatments of the first plasma and the second plasma. In one example sequence, the first plasma can include at least one of air or oxygen, and the second plasma can include a fluorocarbon, such as CF₄, C₂F₆, C₃F₈, or other volatile fluorocarbons. In another example sequence, the first plasma can include at least one of air or oxygen, and the second plasma can include the other of air or oxygen. In an example, the first plasma treatment can include oxygen or air, and the subsequent steps of the sequence can include alternating contact with air and CF₄ plasmas. The steps of contacting the surface with a first plasma to create at least one plasma-treated surface region having a first surface functionality and contacting each plasma-treated surface region with a second plasma to create a second surface functionality can be repeated a plurality of times, including two times, three times, four times, five times, six times, up to eight times, or up to 10 times.

### EXAMPLES

The following Examples haves been presented in order to further illustrate the invention and are not intended to limit the invention in any way. The statements provided in the Examples are presented without being bound by theory.

### Example 1

### 1. Introduction to Example 1

Medical implants are either tissues or devices that are inserted into or on the outside of part the body [1]. The purpose of many implants is to replace lost body components with prostheses while some of the implants give support for organs, monitor biological processes, or provide medicine. Certain implants such as skin, bone, and natural tissues, whereas, some others are constructed of ceramic [2], metal [3], polymer [4], or other substances [5]. Polymer and plastic-based materials such as acrylics and polycarbonates are widely used for a variety of purposes and afford advantages due to their natural characteristics. Those materials’ specific properties, such as optical, chemical resistance, biocompatibility, inertness, mechanical durability, and impact resistance make them suitable for medical applications [6].

Polymethylmethacrylate (PMMA) has great optical qualities with strong, stable, lightweight, and biocompatible properties, which makes them suitable for use in medical applications such as bone cement [7], contact lenses [8], bone replacements [9], and drug delivery systems [10]. Since it is not biodegradable like polylactic acid (PLA) based polymers [11], PMMA also has some advantages in permanent implant applications including the artificial cornea. Polycarbonates (PCs) are also widely used as polymeric implant material that combines strength, rigidity, and toughness to assist prevent potentially fatal material failures [12]. It has a wide variety of physical qualities that allow it to replace glass or metal in many medical applications [13]. Unfortunately, polymer based implants surfaces maybe sometimes need to be improved, e.g., to prevent bacterial adhesion on substrate surfaces or enhance tissue compatibility for adhesive properties [14]. The construction of polymer ensures their high biocompatibility and their ability to support biological functions. However, the implant-associated infections may result fatal consequences for a living organism [15]. Bacterial adhesion to the medical implants can also create a biofilm that leads to most infections. Once a surface is contaminated with bacteria, the bacteria begin to form a colony. As the colony continues to grow, it transforms into biofoulings which is a major concern for the medical industry and frequently results in significant financial losses and health problems [16]. Gram-positive and Gram-negative bacteria are the principal microorganisms that cause biofilm formation on medical devices [17]. The biofilm formation starts with the initial attachment of the microorganisms caused by several mechanisms, including polarity, surface free energy, wettability, and London and van der Waals forces [18]. In order to improve and tailor the surface properties of polymer-based medical implants, such as self-cleaning, wettability, and mitigate unwanted bacterial accumulation on the polymer/implant surface, several different methods are applied such as chemical solvents, laser, and UV-irradiations [19]. Plasma treatment is one of the treatment methods for changing the micro/nano-texture of the material by bombarding the surface with the synergism of radicals, ions, electrons, and neutrals which could be a promising method for alleviating the bacterial adhesion on polymer-based medical implants [20]. During plasma processing, all of these species may come into contact with the surface to tailor or specify the surface properties depending on the used plasma gas treatment by selecting the gas composition, power, pressure, and so on.

Here in this Example, low-pressure plasma treatment method was applied using CF₄, O₂, and air gases to functionalize the PC and PMMA polymer surfaces in order to improve surface properties. The surface properties of PC and PMMA attained different plasma gases were evaluated by means of contact angle (CA, θ) measurements and surface free energy (SFE) values. Moreover, several different surface patterns template were used to observe the effect of the shapes and sizes of pattern on plasma-treated polymer surfaces. Dual plasma gases such as CF₄ and air, air and CF₄, O₂ and CF₄, and CF₄ and O₂ plasmas were applied of the polymer surfaces in sequence to establish the tunability of surface properties of PC and PMMA.

### 2. Experimental

Distilled water (DI) (Barnstead, E-pure), and di-iodomethane (99%, Alfa Aesar) was used to determine the SFE, while only DI water were used for contact angle (CA) measurements. Polycarbonate (PC) (Tuffak, Plaskolite, 0.093 inch thick) and Acrylic (PMMA) (Optix, Plaskolite, 100% Polymethyl methacrylate, 0.80 inch thick) surfaces were exposed to different plasma gasses. The PC and PMMA surfaces were rinsed with DI water and dried in an oven under 50° C. Afterward, the samples were stored in a sterile container till they are used in the experiment.

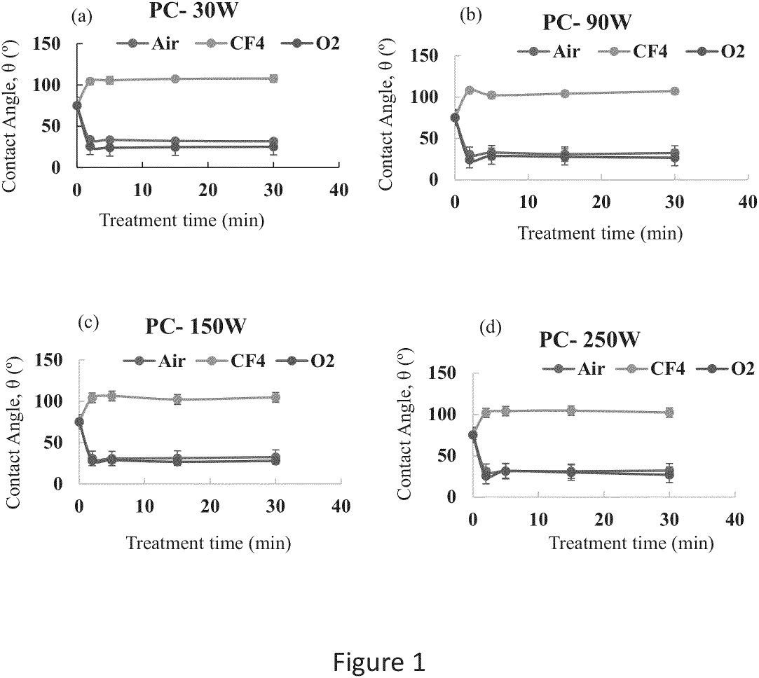

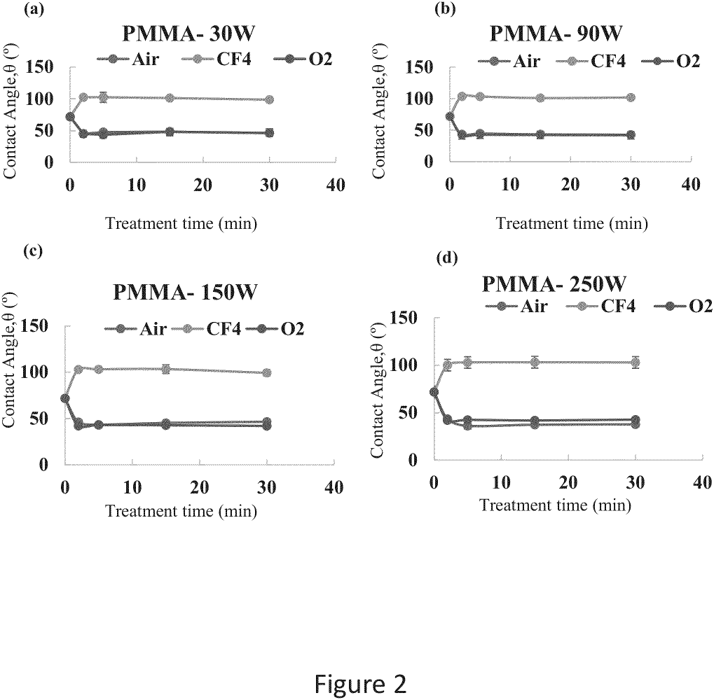

CF₄, oxygen (O₂) were obtained from local vendor (Airgas Co., Tampa, FL), and ambient air gases were used for air plasma treatment. An instrument to obtain the gas plasmas, low-pressure plasma surface technology (Diener Electronic, Femto-AR-PC, Germany) was used to treat sample. Before starting the plasma treatment of each sample, to obtain preferred plasma power and duration, first PC and PMMA surfaces were treated for 30W, 90W, 150W, and 250W power separately, and CA values were measured immediately after treatment. A 90W was found as a preferred power value for both of the surfaces after measurements, as the corresponding results of the measurements were given at FIGS. 1-2. This power value is used to measure the preferred exposure time. Under 90W power, each polymer surface is treated with different plasma gas for 2, 5, 15, and 30 minutes. According to the results, it was found that 2 minutes is a preferred treatment duration for each surface and gas type. The preferred working pressure value of 0.3 mbar was used for the aforementioned gases. Consequently, for plasma treatment conditions of 90W power, 2 minutes exposure time, 0.3 mbar of pressure values were chosen as a condition. The chamber of the plasma machine is depressurized to 0.3 mbar for air, O₂ and, CF₄ gases before use.

To estimate the wettability of each of the surfaces, a contact angle measurement device was used (Biolin Scientific, Attension Theta Flex, USA), with C204A Tilting cradle extension. A 10 µL drop of DI water was put on the surface for CA measurements with a microliter syringe (Hamilton 1001 LT, 1 mL), with help of One Attension software, and observed through an CCD camera, for each surface type. The contact angle value is the average value of at least five repeat measurements taken at various positions on the sample’s surface. Pyrene was used to examine the correlation between plasma gas-treated surfaces and their bonding capabilities through photoluminescence (Edinburgh Instruments, FS5) measurements. For this purpose, 50.2 mg of Pyrene (98%, thermo scientific) was dissolved in 25 ml of ethanol and the obtained solution was used to determine the photoluminescence properties of the polymers. After surfaces were treated with plasma, 10 µL pyrene solution was placed on the polymer surface with a pipette. Then, the droplets left in oven at 50° C. for 2 hours to evaporate. Following this process, the substrate surfaces were washed 3 times with DI water. Finally, the polymer surface gently dried with an air gun. The photoluminescence measurements are done with a 150W Xenon lamb and 355 nm excitation wavelength.

### 2.1. Material Preparation and Plasma Treatment

PC and PMMA surfaces were cut with the laser cutter (FS-Pro LF 36) in size of 1 in. × 1 in. After the cleaning process with DI water, surfaces were left in the oven for 2 hours 50° C. and then the air gun was gently used to avoid unwanted dust on the PC and PMMA surfaces. First, for all-gas type treatments, the pumping down period, the pumping down pressure, power and plasma process duration fixed to 10 minutes, 0.3 mbar, 90 W and 2 minutes, respectively while the chamber temperature is set to 21° C. In order to clean and purify the environment of chamber before starting the surface treatment process, the chamber was exposed to the related gas for 15 minutes which will be used for the plasma process.

### 2.2. Contact Angle Measurements

Contact angle measurements were run under sessile drop mode using 10 µL of DI water droplets with help of a CCD camera and computer software. For each surface and gas combination, at least five different water droplets were used to obtain more accurate results and the results were reported as average values with standard deviation. SFE measurements were performed with two different liquids with different viscosities. DI water, and diiodomethane (99%, Alfa Aesar) were used as the dispersive liquid for calculations. A drop of DI water was put on the PC and PMMA surfaces at 22° C., and the video of drop was captured over the course of 10 seconds, resulting in a total of 325 frames. Each liquid dropped on PC and PMMA surfaces separately, and the process was repeated 5 times as well, for each treatment number. Moreover, used PC and PMMA surfaces were not used again for contact angle or plasma treatment purposes to avoid surface contaminations.

### 2.3. Surface Pattern Designs

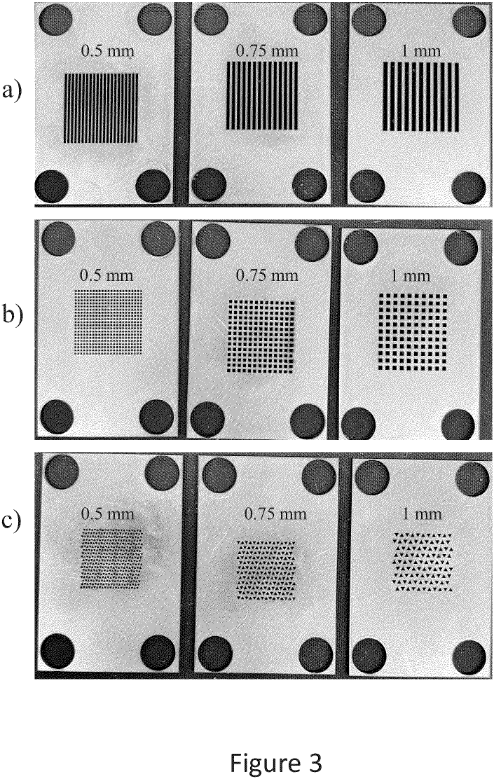

In order to observe the pattern effect on the PC and PMMA surfaces, different customized surface patterns and gaskets (for fixation) are designed by AutoCAD 3D modeling program. Several different shape surface patterns models are designed such as line, triangular, and square with a different pattern size, e.g., 0.50 mm, 0.75 mm, and 1.0 mm. A 1 mm thick stainless-steel sheets were cut with a laser cutter (Mentor 2 laser cutter) in size of 6 cm long and 4 cm wide, as shown in supportive FIGS. 3. As the measurements are as sensitive as the mm range, PC and PMMA surfaces are fixed before treatment to obtain correct results. In order to obtain high sensitivity, the gasket is modeled and cut with the same laser cutter and software. The gasket pattern’s size is designed 0.2 mm smaller than the actual sample. Fixation is attained with the help of screws and nuts which is gently removed after the plasma treatment and before contact angle measurement process.

### 2.4. Dynamic Contact Angle Measurements

Automated tilting cradle were used to estimate contact angle hysteresis (CAH) and slide-off values of each PC and PMMA surfaces with the DI water. The optical camera aligned with the sample through the tilting, which is all automated, makes it possible to get the slide-off angle with the help of software (One Attention). Live analysis was performed with the software while the image recording time is set to 5.5 frame per second (FPS) for 30s capture duration. Since the contact angle is not possible to calculate in a Laplacian fitting, as a consequence of shape of a droplet, polynomial fitting was applied for measurement settings. As soon as droplet was placed to the sample surface, instrument automatically tilted, and the recording started. The recording stopped after drop slide off the surface. Advancing and receding angles are calculated through these measurements to determine the CAH values.

### 2.5. The Measurement in Contact Angle in Different Environments For PC and PMMA Surfaces After Plasma Treatment

In order to analyze pH stability of polymer sample surface, water solutions with different pH, e.g., pH 1 to 11 range were prepared with the help of HCl and NaOH. Moreover, 1 M, 0.1 M, and 0.01 M of NaCl solutions were prepared to analyze the effect of the salinity via contact angle measurements. For each contact angle measurement, 10 µL of prepared pH or NaCl solution was used. Also, to analyze protein adhesion properties of PC and PMMA surfaces, first phosphate-buffered saline (PBS) solution was prepared with the addition of 8 g of NaCl (Fisher chemicals), 0.2 g of KCI (Fisher chemicals), 10.44 g of Sodium phosphate dibasic (Fisher chemicals), and 0.245 g of potassium phosphate monobasic (Fisher chemicals) to 1L of DI water. Then, this PBS solutions was to prepare 15 mM, 1.5 mM, 0.15 mM, and 0.015 mM of Bovine serum albumin (BSA) (Fischer Scientific) solutions. Polymer surfaces washed with DI water before plasma process and dried at oven under 50° C. for 1 hour. As soon as the polymers are treated with plasma, a 10 µL BSA solutions at different concentrations were contacted with polymer surfaces separately and contact angle values were measured.

### 2.6 Surface Free Energy

The wettability of solids by liquids is influenced significantly by surface free energy (SFE). Therefore, it is a relevant metric for optimizing surface coatings, solid-liquid contacts as well as any other sort of interaction at the interfaces including ionic, polar and non-polar interactions. Since SFE is a kind of attractional force and cannot be measured directly, measurements performed by different liquids with different SFEs. In order to do this di-iodomethane and DI water were used to calculate the SFE values of PC and PMMA surfaces with the help of OWRK (Owens-Wendt-Rabel and Kaelble) method that analyses the solid-liquid interface interactions as a sum of two distinct interaction fractions that are the polar and dispersive part. The interfacial tension is determined by whether polar and dispersion components may develop contacts with corresponding sections of the neighboring phase, according to the two-liquid OWRK model as shown in Eq. 1

$${γ}_{L V} \left(1 + c o s θ\right) = 2 \left(\sqrt{} \left({γ}_{L {V}^{d}} {γ}_{S {V}^{d}}\right) + \sqrt{} \left({γ}_{L {V}^{P}} {γ}_{S {V}^{P}}\right)\right) \qquad \text{(1)}$$

After that, γ_{LV}(1+cosu)=2(Îγ_{LV^{d}}γ_{SV^{d}})+(Îγ_{LV^{p}}))(( is the total surface free energy of the solid-liquid surface. SFE are calculated and resulted by computer software (One-Attension) according to OWRK equation.

### 2.7. X-Ray Photoelectron Spectroscopy (XPS) Analysis

X-ray photoelectron spectroscopy (XPS) was performed to analyze and observe the change in the surface chemistry of untreated, and CF₄, air and O₂ plasma treated PC and PMMA samples. Perkin Elmer PHI 5400 LS was used for the analysis with Al K-alpha X-ray source. XPS run under 350 watts power with 8.9 eV pass energy. All PC and PMMA surfaces were placed XPS’s ultra-high vacuum as soon as treated with plasma.

### 2.8. Multiple Plasma Treatment of PC and PMMA Surfaces

To observe the effects of the multiple plasma treatment on PC and PMMA surfaces, the sequential plasmas treatments of CF₄-O₂, O₂-CF₄, Air-CF₄, and CF₄-Air were applied. First, the PC surface was treated with CF₄ plasma under preferred conditions (90W, 2 minutes, 0.3 mbar), and right after, O₂ plasma was applied to the same surface under preferred plasma treatment conditions. The process was repeated up to 6 times and CA values were measured between each plasma treatment. For the next PC surfaces group, PC surfaces were first treated with O₂ plasma, and CF₄ plasma was applied right after O₂ plasma treatment. For the next gas plasma treatment, PC surfaces are first treated with CF₄ plasma under preferred conditions and the air plasma is applied after CF₄ plasma treatment. This procedure was also repeated 6 times in a row and contact angle values were measured right after each treatment. Then, air plasma was used as the primary plasma while CF₄ plasma was applied as the secondary and the same procedure was applied to PC surfaces. All plasma processes run under preferred conditions as given earlier. Similarly, to PC surfaces, exactly the same experimental setup was conducted, and the same plasma conditions were also applied for PMMA surfaces and the contact angle values were measured as soon as plasma treatment done.

### 2.9. Photoluminescence Spectroscopy Measurements

Firstly, all PC and PMMA surfaces are treated with CF₄, air, and O₂ plasmas separately, under preferred plasma conditions. Right after these plasma treatments, a 10 µL of fluorescence probe solution prepared with using pyrene, and placed onto plasma treated polymer surfaces via a pipette, and placed into an oven at 50° C., for evaporation for 2 hours. Later, the obtained surface was washed 3 times with DI water and dried with an air gun before photoluminescence measurements.

### 3. Result and Discussion

### 3.1. Effects of Plasma and Surface Pattern on the Polycarbonate and PMMA Surfaces

The PC and PMMA surfaces are first treated with different gasses at preferred treatment conditions without any surface pattern. Untreated PC and PMMA surfaces exhibited relatively similar contact angle values, 77.32°±0.80° and 70.18°±0.47° respectively. The same gas plasma gases applied to surface of polymers five times in a row in order to observe the changes in CA with the number of treatments. After being treated with plasma, the CA values were decreased down to 29.34°±0.14° for PC while it decreased to 43.99°±0.22° for PMMA surface as shown in Table 1. CA values were decreased with the increasing number of treatments for O₂ and air plasmas. In O₂ plasma process, the reactive species containing oxygen atom that formed during plasma can react with the substrate surface, hydrocarbon, causing new functional groups via chemical bonding. Polar groups such as —OH, —O—, —C(O)— and —COOH make the surface relatively more wettable or hydrophilic [21]. Since PC and PMMA chemical structures are different, the generation of new polar groups and bonding hence the wettability capacities are expected to be different.

TABLE 1

The change in Contact Angle (CA) values of polycarbonate (PC) and polymethylmethacrylate (PMMA) surfaces upon Air, CF₄ and O₂ plasma treatment up to 5 consecutive applications
PC Surface

| Number of Treatment | CA for Air Plasma (°) | CA for CF₄ Plasma (°) | CA for O₂ Plasma (°) |
|---|---|---|---|
| 0 | 70.18±0.47 | 70.18±0.47 | 70.18±0.47 |
| 1 | 34.97±1.10 | 100.12±0.97 | 31.69±0.23 |
| 2 | 31.39±0.42 | 102.23±0.20 | 31.02±0.20 |
| 3 | 30.65±0.44 | 105.31±1.0 | 27.61±0.54 |
| 4 | 30.50±1.01 | 107.92±1.12 | 25.32±0.77 |
| 5 | 29.34±0.14 | 109.04±0.35 | 25.36±0.95 |

After being treated with air plasma, the surfaces became more hydrophilic since the production of high energy surface groups in interactions between the native surface groups of the polymer and the reactive plasma species [22]. Polymer surfaces exposed to air plasma which contains different groups such as oxygen or nitrogen plasmas can induce new functional groups on the surfaces which increase wettability. For O₂ plasma treatment, the same plasma procedure was applied for both polymer surfaces. As a result, CA values of 25.32°±0.77° and 39.94°±2.05° were measured for PC and PMMA, respectively. O₂ plasma treatment showed relatively better wettability than air plasma treatment, the reason for this may be existence nitrogen species in the air plasma and the more reactive nature of O₂ plasma species as well as the possibility of better etching by O₂ plasma species. Since the polymers are naturally hydrophobic and with the increasing functionality with O₂ plasma species as well as the possibility of etching, the hydrophilicities are also increase because of Wenzel regime [23]. Finally, after CF₄ gas plasma treatment, both polymer surfaces exhibited more hydrophobic nature e.g., higher CA values due to fluorination process [24]. During fluorination process, hydrogen atoms may be replaced by fluorine atoms which chemical process generating fluorinated species on the surfaces [25]. After being treated with CF₄ plasma, the CA values increased to 109.04°±0.35° for PC surfaces, whereas it was increased to 105.76°±0.61° for PMMA surfaces.

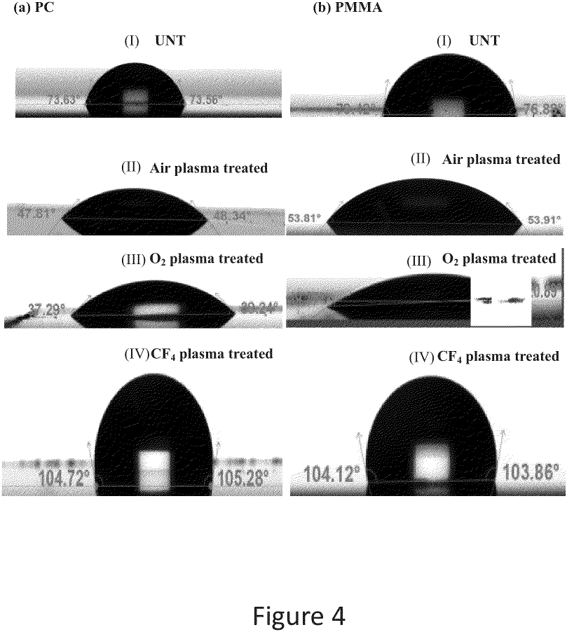

Both of the surfaces exhibited very similar hydrophilic and hydrophobic characteristics upon O₂, air and CF₄ plasmas treatments under the same plasma conditions according to CA measurements as shown in FIG. 4.

Surface patterns generated on steel plates with different motifs were also used as mask to treat the surface of polymer upon plasma exposure. Using a triangular surface pattern, O₂ plasma was applied to PC surfaces under preferred conditions. For 0.5 mm, 0.75 mm, and 1 mm pattern sizes, the CA values were 49°±1.08°, 51.34°±2.0°, and 51.37°±1.51°, respectively for O₂ plasma treated PC surfaces. In addition, the CA values were measured as 61.9°±1.25° for CF₄ treatment and under a 0.5 mm triangular surface pattern, compared to 61.78°±1.84° and 61.9°±1.40° for 0.75 mm and 1 mm pattern sizes, respectively for PC. The CA values, for the identical studies, conducted with air plasma for PC surfaces and triangular surface pattern, were 52.38°±1.29°, 54.8°±2.60°, and 52.33°±1.72° for pattern sizes of 0.5 mm, 0.75 mm, and 1 mm, accordingly.

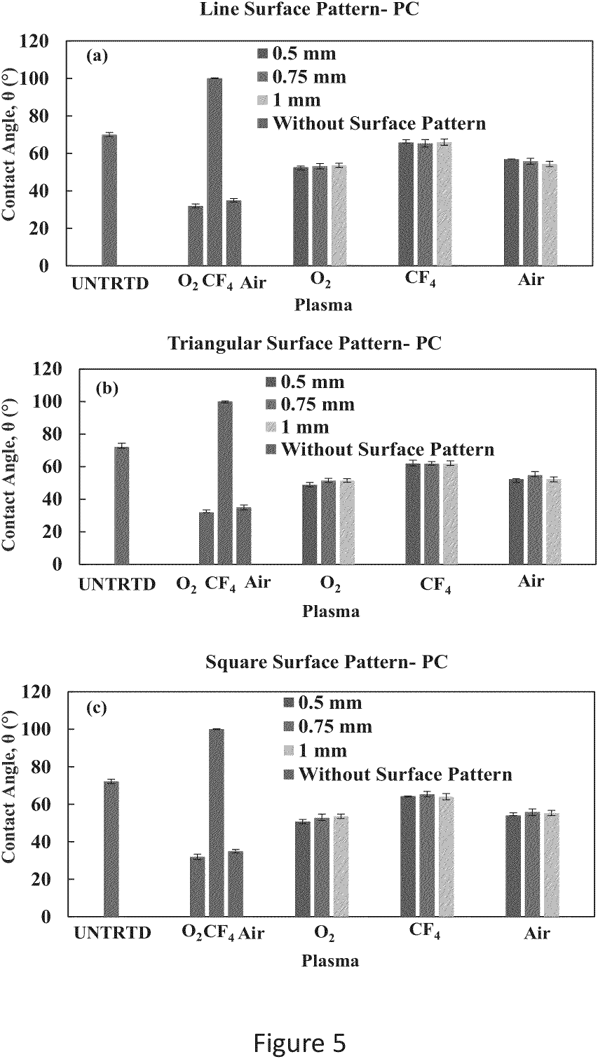

The same plasma operation was then carried out again, this time using a square surface pattern and the results were quite comparable to the size of the triangle design. After being exposed to O₂ plasma, the CA values for the 0.5 mm, 0.75 mm, and 1 mm pattern sizes were found as 50.81°±0.93°, 52.77°±0.74°, and 53.55°±1.15°, respectively, for PC surfaces. CF₄ treatment, the surface pattern’s CA were 64.32°±1.25° for 0.5 mm, 65.36°±2.48° for 0.75 mm, and 64.02°±1.21° for 1.0 mm pattern size for PC surfaces. After being exposed the PC surfaces to air plasma, under square surface pattern, the contact angle values for the 0.5 mm, 0.75 mm, and 1.0 mm pattern sizes were found as 54.03°±2.13°, 55.89°±1.46°, and 55.34°±1.94°, respectively. Finally, PC surface was placed under line surface pattern. The CA values for 0.5 mm, 0.75 mm, and 1.0 mm line pattern sizes were measured as 52.66°±1.47°, 53.20°±1.59°, and 53.55°±1.86° under preferred plasma conditions for O₂ plasma treatments. Additionally, with CF₄ treatment, for PC surface, it was determined to be 65.74°±2.01° for 0.5 mm pattern size, 65.33°±0.54° and 66.048°±1.75° for 0.75 mm and 1.0 mm pattern sizes, respectively. CA values were similar for O₂ with air plasma treated surfaces, and they were 56.95°±1.56° for 0.5 mm, 55.80°±1.16°for 0.75 mm, and 54.35°±1.68° for 1.0 mm line pattern size, as illustrated in FIG. 5.

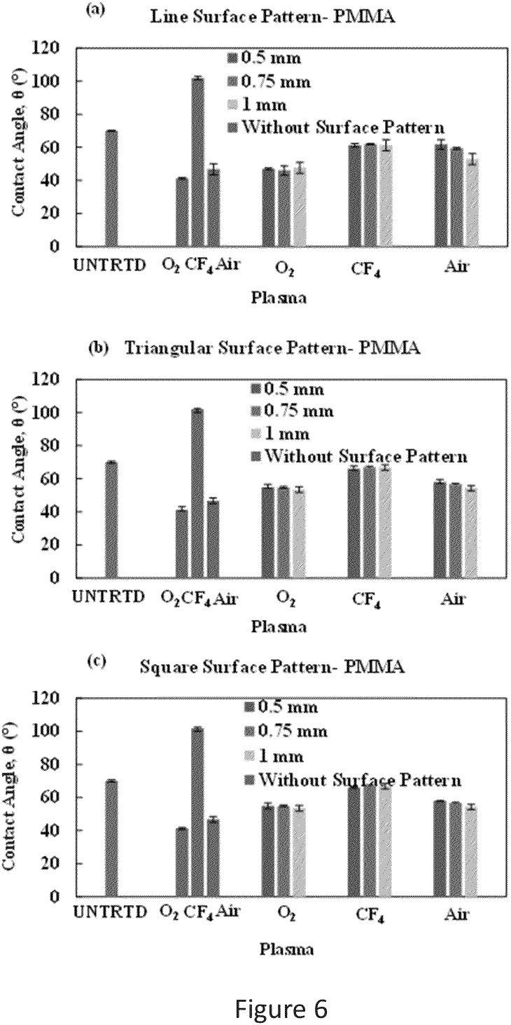

Under each surface patterned template, PMMA surfaces were also treated with CF₄, O₂, and air plasmas. PMMA surfaces’ CA values were measured as 53.79°±0.62°, 54.62°±1.82°, and 53.43°±0.27° for 0.5 mm, 0.75 mm, and 1.0 mm pattern sizes, correspondingly, under triangular-shaped pattern size and being irradiated by O₂ plasma. In addition, CA values were increased with following CF₄ treatment, reaching 65.86°±0.88° for 0.5 mm, 66.80°±0.76° for 0.75 mm, and 66.74°±1.34° for 1.0 mm pattern size, as shown in FIGS. 6.

Moreover, air plasma treatment showed CA values that were comparable to O₂ plasma treatment of PMMA surfaces. After being treated with air plasma, the CA value was measured using a 0.5 mm at 57.76°±1.54°, whereas it was measured as 56.49° ± 0.75° and 54.35° ± 1.68° for 0.75 mm and 1.0 mm pattern sizes, respectively, for triangular surface pattern. The CA values were determined to be 48°±0.47°, 49.54°±0.43°, and 50.12°±1.02° for square pattern mask for O₂ plasma with the pattern sizes of 0.5 mm, 0.75 mm, and 1.0 mm, respectively. Additionally, for 0.5 mm, 0.75 mm, and 1.0 mm pattern sizes, the CA values were increased to 63.15°±0.22°, 60.25°±1.12°, and 58.12°±0.78° with CF₄ plasmas treatment whereas they lowered to 44.45°±0.22°, 47.12°±1.12°, and 48.55°±032° upon treated with air plasmas. For PMMA surfaces, a line designed mask was applied with oxygen plasma, and the CA values changed for the pattern sizes of 0.5 mm, 0.75 mm, and 1.0 mm as 55.35°±0.71°, 48.96°±1.16°, and 49.32°±1.27°, respectively. Additionally, the values of CA for CF₄ plasma applied surfaces for 0.5 mm, 0.75 mm, and 1.0 mm pattern sizes line surface pattern were raised to 61.19°±1.44°, 61.9°±0.87°, and 59.28°±0.47°, respectively. Finally, the contact angle values for line forms and surface pattern size decreased as a result of the air plasma treatment.

### 3.2. Surface Free Energy Measurements

The surface tension of dispersive group (di-iodomethane) is given as 50.8 mN/m while it is 72.8 mN/m for polar (DI water) group, at room temperature [26]. According to measurements, the untreated PC surfaces SFE values was found as 41.16±0.42 mN/m. However, PC surface SFE was significantly increased up to 57.59±1.12 mN/m after treated with air plasma as a result of the introduction of hydrophilic groups such as hydroxyl and carboxyl groups to the surface. The introduction of these polar groups raises surface energy and turn into more hydrophilic surface by reducing the contact angle [27]. This hydrophilic transition may increase the size of the contact surface, which will enhance adhesion and increase the adaptability of the sample interaction in a moist environment. In addition, SFE values for PC surfaces treated with CF₄ plasma decreased as low as 10.23±0.63 mN/m due to the generation of non-polar and/or hydrophobic groups on PC surfaces. After treating PC and PMMA with air, CF₄ and O₂ plasma gases up to 5 times, the obtained SFE values are summarized in Table 2.

TABLE 2

The change in surface free energy (SFE) values of PC and PMMA surfaces after multiple Air, CF₄ and O₂ plasma treatments
PC Surface

| Number of Treatment | Air Plasma (mN/m) | CF₄ Plasma (mN/m) | O₂ Plasma (mN/m) |
|---|---|---|---|
| 1 | 56.79±1.12 | 13.40±1.10 | 60.54±0.97 |
| 2 | 55.67±0.95 | 12.52±0.90 | 61.14±1.15 |
| 3 | 57.59±0.45 | 10.23±0.63 | 59.48±0.43 |
| 4 | 54.89±0.56 | 12.38±0.96 | 62.26±1.14 |
| 5 | 55.31±1.19 | 11±0.87 | 60.36±0.74 |

CF₄ plasma treatment leads in an increase in fluorine reactive species, including nonpolar CF₂ double bonds, -CF₃ and etc. that changes the surface hydrophobicity and causes an increase in CA. As a result, the hydrophilic material becomes hydrophobic when the nonpolar group is introduced, altering the contact surface and reducing the Van der Waals force [28]. Finally, SFE values increased to approximate value of 60.42±1.12 mN/m after being treated with O₂ plasma, which also increases the wettability of PC surfaces. Similar results were obtained for PMMA surfaces as well under the same measurement procedure. Untreated PMMA surfaces SFE mean value was found as 35.9±1.12 mN/m. After being treated with O₂ plasma, the mean value of SFE increased to 59.12± 0.32 mN/m as a result of introducing the carboxyl group on substrate surface. Moreover, air plasma treated surfaces exhibit similar surface behavior to O₂ treated PMMA surfaces. Air treated surfaces SFE mean value increased to 60.01±0.96 mN/m which also makes surface more wettable. CF₄ plasma treated surface’s mean SFE value decreased to 13.12±0.59 mN/m as like PC surfaces.

### 3.3. Contact Angle Hysteresis

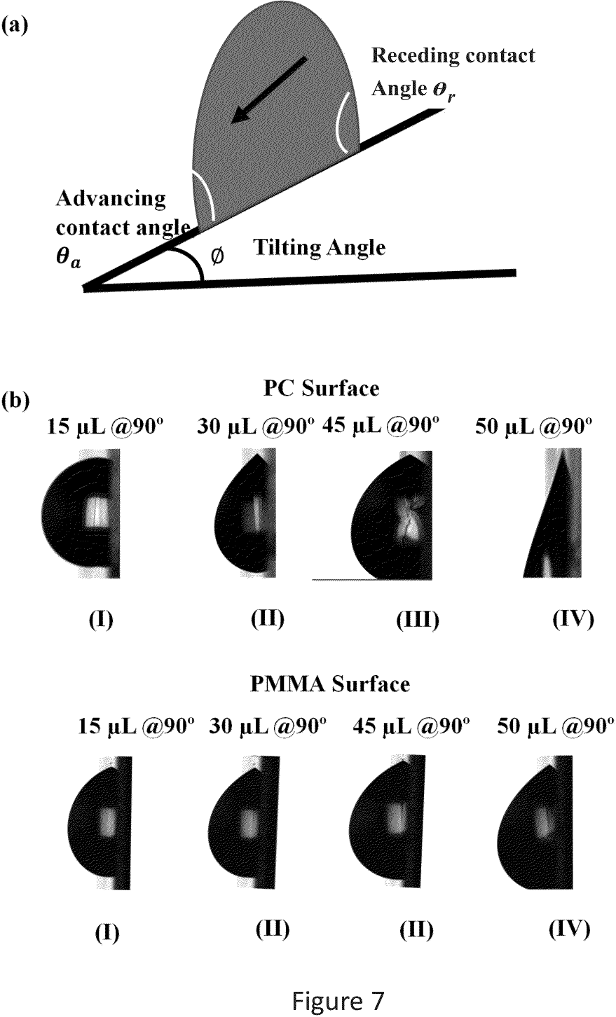

Measurements of static CA can occasionally provide challenges. This is mostly due to the fact that multiple and steady contact angles might be recorded on the same surface. This is observed in real-world situations when values for CA depend on measurement. Moreover, the static contact angle cannot reveal the exact composition of the sample surface[29]. In order to make a more detailed analysis of the substrate surface, the dynamic CA method can be used in addition to the static CA. The advancing (maximum CA on the surface) and receding CA (lowest contact angle on the surface) used to estimate the CA hysteresis (CAH) which is the difference between these values [30]. For an ideal surface, the CAH value is supposed to be zero. However, as a consequence of in-homogeneity for all surfaces, the CAH value is always greater than zero for real world applications[31]. Moreover, it is beneficial to understand the type of forces operating on liquid droplets and their mobility on a solid surface to describe those forces. Young’s equation relates the interfacial energy and the CA. Unfortunately, measuring the equilibrium CA is difficult. Depending on how the drop is positioned, the CA, for instance, can take on any value between the advancing and receding contact angles which is known as CAH. The semi-empirical description which links the tilt angle to the forces operating at the advancing and receding edges of the droplet, is the starting point for the majority of contemporary analyses of the initiation of droplet motion when a surface is tilted to “slide-off angle”[32]. Several different physical forces affecting the droplet are illustrated at FIGS. 7.

The easiest way to calculate advancing and receding angles is changing the angle of the tilted plate. By inclining and declining sample holder supporting surface, gravitational forces can be increased until the critical angle which drops start sliding from substrate surface. Equation (Eq.2) for the sliding angle of a drop is found by making this lateral adhesion force equal to the lateral component of the gravitational force, mgsinø.

$$sin ∅ = \frac{w {γ}_{{L}^{k}}}{m g} \left(c o s {θ}_{r} - c o s {θ}_{a}\right) \qquad \text{(2)}$$

Gravitational acceleration, which g = 9.81 m/s², m is the mass of the DI water drop, ø is the sliding angle (tilting angle), w is width of the drop, θᵣ and θ_{α} are receding and advancing angle, and ʏ_{L}^{k} is the surface tension. Mass of the DI water is also related with volume (V) and density (p). Consequently, sliding angle is also related with the volume of a drop. Since gravitation force is fixed, and not sufficiently powerful to cause sliding, in order to start sliding process in observable tilting range, volume of droplet increased from 10 µL to 50 µL for this experimental section. Consequently, for proper measurement, first, 50 µL of DI water was placed on both PC and PMMA surfaces after each gas treatment. CCD camera recording and tilting process started immediately after placing the DI water droplets on the surface with the syringe. For untreated PC surfaces, advancing and receding CA were found as 101.48°±0.33° and 65.60°±0.11° respectively for 34.77°±0.50° slide-off angle while it is 135.12°±1.10° and 62.14°±0.12° for CF₄ plasma treated surface at 47.23°±0.54° slide-off angles. Besides, after being treated with air plasma, advancing and receding angles reduced to 38.15°±0.82° and 17.15°±0.48° respectively with a 21.45°±1.20° slide-off angle. Finally, as with air and O₂ plasma treated PC surfaces advancing and receding contact angles reduced to 36.14°±0.14° and 20.56°±1.10°, respectively. Relatively similar results were observed for PMMA surfaces as summarized in Table 3. As PC surfaces, after CF₄ plasma treatment, the advancing and receding values have increased to the values of 117.19°±0.14° and 55.41°±0.37° respectively for PMMA. Besides, 47.30°±0.21° and 21.65°±0.10° advancing and receding angle values were observed respectively, after being treated with air plasma. Moreover, as a consequence of O₂ plasma treatment, advancing and receding angles reduced to 48.36°±0.14° and 12.70°±0.67° degrees respectively.

TABLE 3

Contact Angle Hysteresis (CAH) values of PC and PMMA surfaces after different plasma gas treatments
PC Surface

| | Untreated | Air Plasma (mN/m) | CF₄ Plasma (mN/m) | O₂ Plasma (N/m) |
|---|---|---|---|---|
| Advancing angle (degree) | 101.48±0.33 | 38.15±0.82 | 135.12±1.10 | 36.14±0.14 |
| Receding angle (degree) | 65.50 ±0.11 | 17.19±0.48 | 62.14±0.12 | 20.56±1.10 |
| Hysteresis (degree) | 36.28±0.22 | 20.96±0.34 | 72.98±0.98 | 15.58±0.96 |
| Slide-off angle (degree) | 34.77±0.50 | 21.45±1.20 | 47.23±0.54 | 28.16±0.74 |

TABLE 3 (continued)

PMMA Surface

| | Untreated | Air Plasma (mN/m) | CF₄ Plasma (mN/m) | O₂ Plasma (mN/m) |
|---|---|---|---|---|
| Advancing angle (degree) | 93±0.64 | 47.30±0.21 | 117.19±0.14 | 48.36±0.14 |
| Receding angle (degree) | 61.60±1.19 | 21.65±0.10 | 55.41±0.37 | 12.70±0.67 |
| Hysteresis (degree) | 31.4±0.55 | 25.65±0.11 | 61.78±0.23 | 35.66±0.53 |
| Slide-off angle (degree) | 24.49±1.14 | 23.10±0.50 | 52.10±0.20 | 33.16±1.03 |

The final obtained results clearly indicate that for both PC and PMMA surfaces, the CAH increased by CF₄ plasma treatment which also shows that adhesion and wettability were decreased. O₂ and air plasma treatments decreased CAH degree which also increased adhesion and wettability.

### 3.4. The Change in the Sliding Angle Upon Plasma Treatment of PC and PMMA Under Different Pattern Shaped Masks

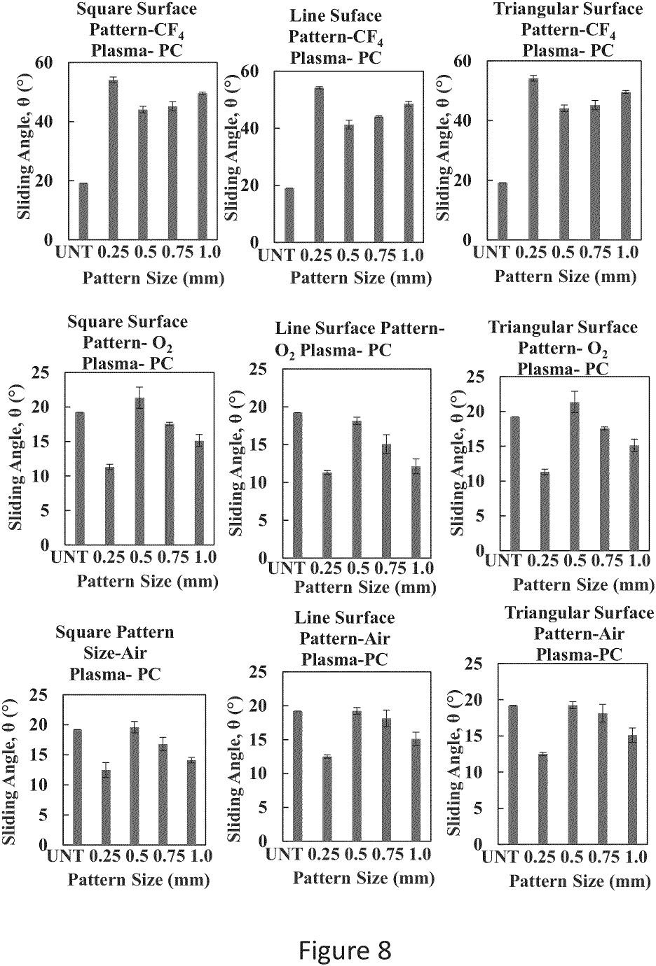

To observe effects of the different pattern shape and pattern sizes on the sliding angle, PC and PMMA surfaces were treated using different surface pattern masks and plasmas. Normally, 50 µL of DI water is sufficient enough to slide for an observable tilting range. However, since surface patterns are in mm region, in order to increase the sensitivity of the starting point of sliding angle, 70 µL of DI water was used. The sliding angle was found as 19.21°±0.42° and 19.57°±1.13° for PC and PMMA surfaces respectively. For PC surfaces, after being treated with CF₄ plasma, the sliding angle increased to 54.15°±1.13°. However, after being treated with a 0.5 mm square mask, the sliding angle decreased to 40.24°±0.7° while it was decreased to 44.8°±0.89° and 48.27°±1.2° for 0.75 mm and 1.0 mm square surface patterns, respectively. Similar results were observed for line and triangular surface patterns. Moreover, the sliding angle decreased to 11.32°±0.32° upon treatment with air plasma without any surface pattern. However, with 0.5 mm triangular surface pattern, the sliding angle increased to 17.12°±1.54° while it was measured as 17.56°±0.23° and 15.12°±0.9° for 0.75 mm and 1.0 mm mask patterns. Very similar relations were observed for air plasma treated samples as illustrated in FIG. 8.

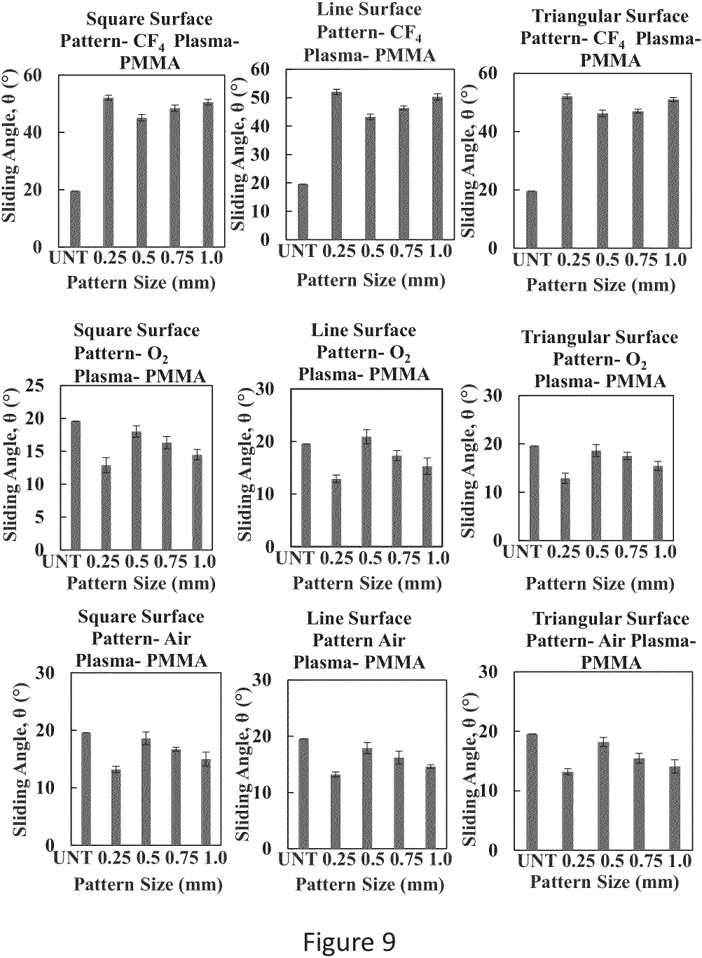

PMMA surface was also treated under the same treatment conditions as PC. After being treated with CF₄ plasma using a square surface pattern, the sliding angle was decreased from 52.10°±0.89° to 45.12°±1.12° for 0.5 mm, 48.45°±1.4° for 0.75 mm and 50.56°±1° for 1.0 mm masks sizes, respectively. Similar results were found as shown in FIG. 9. Moreover, the sliding angle was increased for triangular, square, and line surface patterned masks. For example, for O₂ plasma treated surface under a triangular surface pattern, the sliding angle was increased from 12.9°±1.08° to 18.63°±1.23°, 17.5°±0.78° and 15.45°±0.95° for 0.5 mm, 0.75 mm and 1.0 mm masks sizes, respectively.

Finally, after treated with air plasma, the obtained results indicate that all surface patterns and sizes are affected in the same way as O₂ plasma treatment for PMMA surfaces.

### 3.5. The Measurement of CA in Different Environmental Conditions for PC and PMMA Surfaces After Plasma Treatment

Both in nature and in the human body, the pH of the environment has a significant impact. In the human body, the pH varies from 1 to 8 [33], and the pH of various body fluids differ. For instance, the pH of saliva ranges from 6.5 to 7.5 and that of the stomach is 1.5 to 4 pH, and that of the small intestine is 7.2 to 7.5 pH [34,35]. Even for certain organs, such as the eye, the acidity varies throughout the day and night (average pH 7.25) [33]. As a consequence, polymer-based implants should be able to maintain their forms and characteristics without being affected by different acidic and basic environments. For example, Orthodontic Temporary Anchorage devices (TADs) are exposed to a variety of physical and chemical molecules that might be harmful, and these species can impair corrosion resistance or metal ion release etc. depending of the nature of their materials [36]. In order to observe the pH stability of PC and PMMA surfaces after plasma treatment, different pH solutions were prepared in pH range 1-11 pH and contacted with the polymers and the CA values are measured.

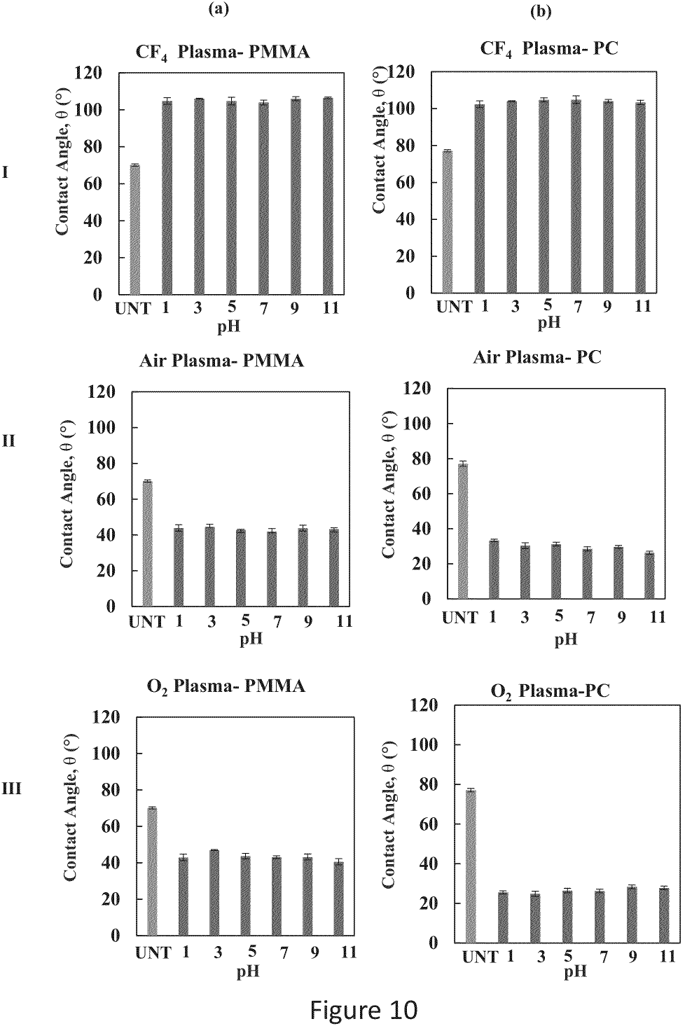

For PC surfaces, after treated with CF₄ plasma under ideal plasma conditions, 10 µL of solutions with a pH value of 1, 3, 5, 7, 9, and 11 were placed on the polymer surface, and the changes in CA was measured. As a result, CF₄ plasma treated surface exhibit 103.87°±1.12° contact angle mean value against all pH solution, as shown in FIGS. 10. O₂ plasma treatment is also done for PC surfaces with the same procedure for CF₄ plasma treatment. The result shows that the PC surface is stable against all pH rates with a 43.40°±1.22° contact angle mean value. Also, upon treated with air plasma treatment, different pH solutions were placed onto PC surfaces. Air plasma-treated PC surfaces exhibit relatively similar CA values with the mean value of 43.36°±1.19° against different pHs.

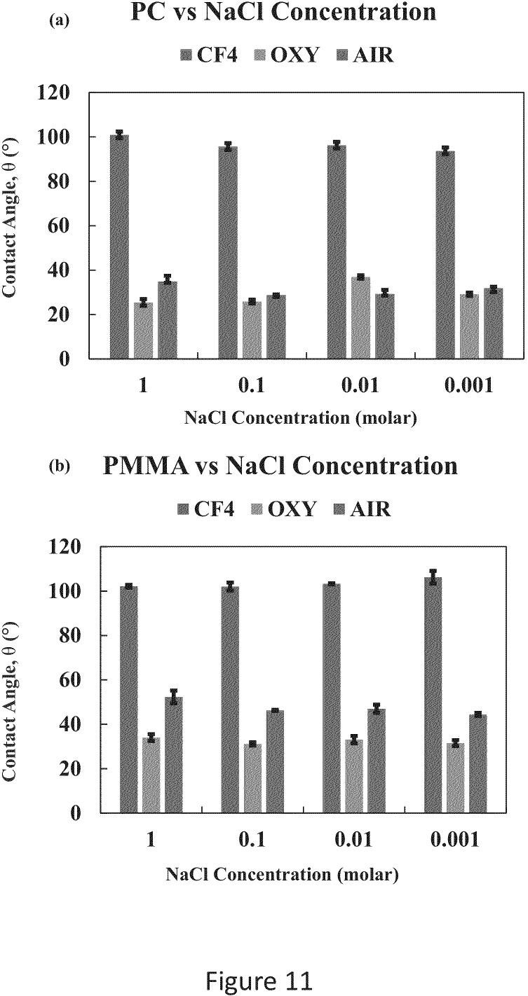

The same experiment applied to PMMA surfaces; after treated with CF₄ plasma, PMMA surfaces showed similar CA values against different pH solutions. After measurements of each pH, the average CA value was found as 103.5°±0.92°. Moreover, the air plasma treated PMMA surface mean CA value was found as 43.35°±1.05° against different pH solutions. Finally, O₂ plasma treated PMMA surfaces showed a similar CA values like air plasma treated PMMA surfaces with the average CA value of 43.40°±1.28°. Moreover, PC and PMMA surfaces CA values were measured against different NaCl solutions e.g., 1.0, 0.1, 0.01 and 0.001 Molar using 10 µL of the corresponding NaCl solutions that were placed on the PC and PMMA surfaces. The CF₄ plasma treated PC surface showed stable CA with an approximate value of 96.61°±1.2° while it was found as 29.32 ±0.42° and 31.20°±1.13° for O₂ and air plasma treated surface, respectively as shown in FIGS. 11. Similarly, the CA values for PMMA surfaces were measured as 103.39°±0.88°, 32.43°± 00.67° and 47.47°±1.18° for CF₄, O₂ and air plasma treated surfaces respectively. After treating PC surfaces with CF₄ plasma under preferred plasma conditions, a 10 µl of BSA solution, with different concentrations e.g.,15 mM, 1.5 mM, 0.15 mM, and 0.015 mM, was placed onto PC surface to measure the CA. According to obtained results, for PC surfaces, the CA value was found to be about 98.28°±1.15° for all BSA concentrations. Moreover, the same measurement was done for O₂ plasma-treated PC surfaces, and the CA values were measured as 29.78°±0.94° for different BSA concentrations. After being treated with air plasma, PC surfaces exhibited very similar CA values as O₂-treated PC surfaces. CA mean values were found as 33.75°±1.20° for all BSA concentrations, respectively, for air plasma.

Also, aforementioned CA measurements for BSA solutions were done for PMMA surfaces. After treated with CF₄ plasma, the CA value for PMMA surfaces values were measured as 106.42°±0.85° at all BSA concentrations. On the other hand, the mean CA value was found as 31.79°±1.77° for all BSA concentrations, after being treated with O₂ plasma. Finally, the PMMA surfaces treated with air plasma and the mean CA values were found as 44.09°±1.32° at all BSA concentrations.

### 3.6. X-Ray Photoelectron Spectroscopy (XPS) Measurements

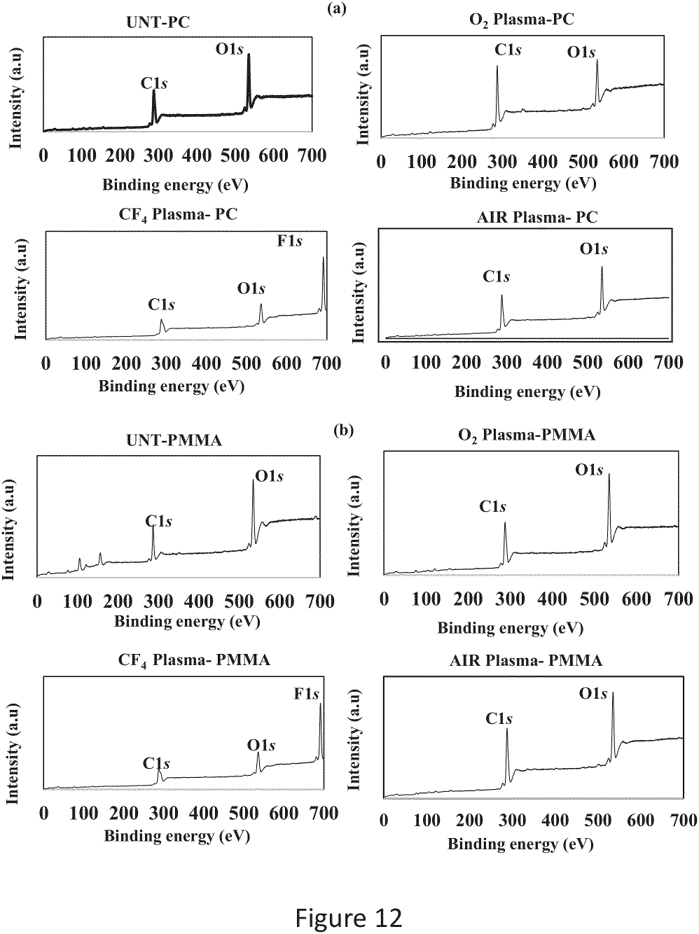

XPS analysis were used to corroborate the changes in the surface functionality of PC and PMMA upon treatment of different gas plasmas. As illustrated in FIGS. 12, for PC surfaces and after their functionalization, the XPS measurements were carried out. The XPS full survey spectra in the binding energy range of 0-800 eV for untreated, O₂ plasma, CF₄ plasma, and air plasma treated PC surfaces were shown in FIG. 12(a). As shown in the Figure, all of PC samples contain C1s group at 287.25 eV and O1s at 535 eV binding energy. After treated with CF₄ plasma, F1s fluorination peak appeared as a shar and more intensive confirming the presence of F atoms on the surface. Moreover, after treatments with air plasma, O1s peak got more intense in comparison to untreated PC surface.

The same measurements repeated for PMMA surfaces and for all PMMA surfaces, C1s binding energy at 287.25 eV and O1s at 535 eV were observed. Also, after treated with CF₄ plasma, the F1s fluorination peak intensity was appeared in comparison to untreated sample. Also, after air plasma treatment, intensity for O1s is increased in comparison to untreated PMMA surface. XPS results indicates that for both PC and PMMA surfaces, low-pressure plasma treated surfaces are functionalized by fluorination upon CF₄ plasma treatment and functionalized with oxygen containing groups after being treated with O₂ and air plasma treatments.

### 3.7. Multiple Surface Treatment of PC and PMMA Surfaces With Plasma

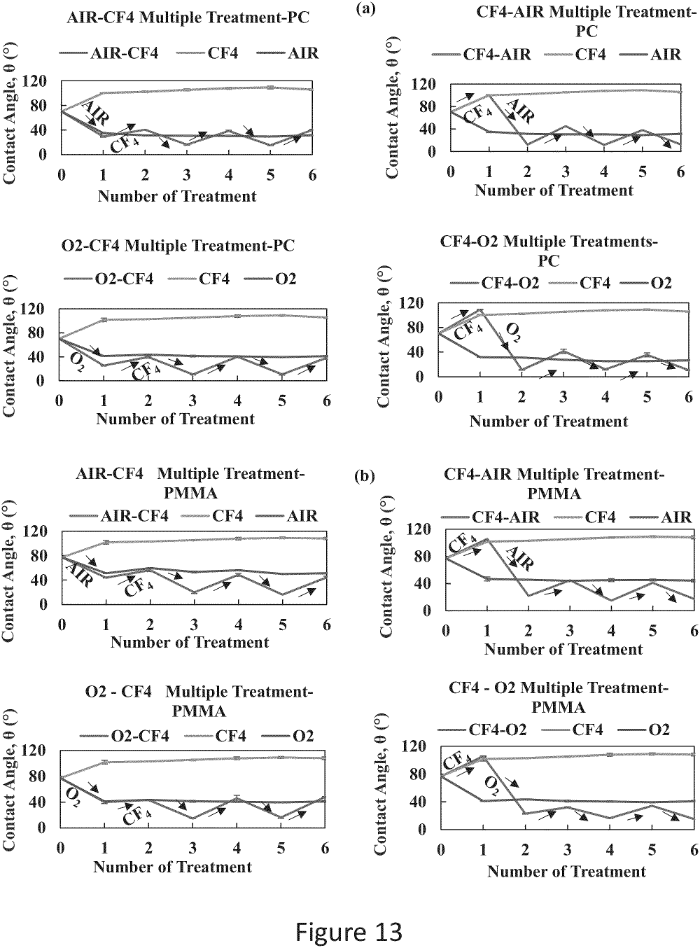

To assess the effect of multiple plasma treatments on PC and PMMA surfaces, the sequential treat of CF₄-Air, Air-CF₄, O₂-CF₄, and CF₄-O₂ plasmas were carried out separately. Intriguing results were obtained after sequential plasma treatment for PC and PMMA surfaces. As mentioned in section 3.1, the CA value were decreased from 70.18°±0.47° to 25.32°±0.77° after treated 5 times with O₂ plasma for PC surfaces. However, when O₂ plasma is applied after CF₄ plasma, the CA value was decreased as low as 10.62°±0.88°. Similarly, while only air plasma-treated PC surfaces decreased as low as the contact angle of 29.34°±0.14° with a number of sequential treatments was applied after CF₄ plasma treatment e.g., air, the CA values decreased as low as 11.65°±1.78° as shown in FIGS. 13. Moreover, only CF₄ plasma-treated PC surfaces CA values can be increased from 70.18°±0.47° to 109.04±0.35 in the same manner. Also, the CA value can only be reduced as low as 35.59°±3.18° and 38.09°±2.09° upon applying O₂ and Air plasma separately, respectively.

For PMMA surfaces, similar results were observed upon sequential plasma gas treatments. For example, the PMMA surfaces were treated 5 times in a row with air plasma, the contact angle value decreased from 77.32°±0.80° to 45.13°±1.06°. However, when the sequential gas treatment applied for example, upon air or O₂ is applied after CF₄ plasma, the CA value decreased as low as 14.96°±0.2°. The O₂ plasma treated PMMA surfaces contact angle decreased as low as 39.94°±2.05°. However, the O₂ plasma treated were done after CF₄ plasma treatment, the CA was decreased to 15.23°±0.42°. Therefore, for all polymer and gas groups, the CA values were decreases upon CF₄ plasma treatment due to fluorination of the surface functional groups, and the wettability increase (CA decreases) with the air and O₂ plasma treatments due to formation of hydrophilic groups such as hydroxyl and carboxyl etc., the subsequent use of plasma gas can render the desired functionality on polymer surface without use of any chemicals as clean method. Therefore, the surface functionalization of polymer can be readily accomplished by appropriate choice of plasma gasses ad their sequential applications.

### 3.8. Photoluminescent Properties of PC and PMMA Surfaces after Treated with Different Plasma Gases

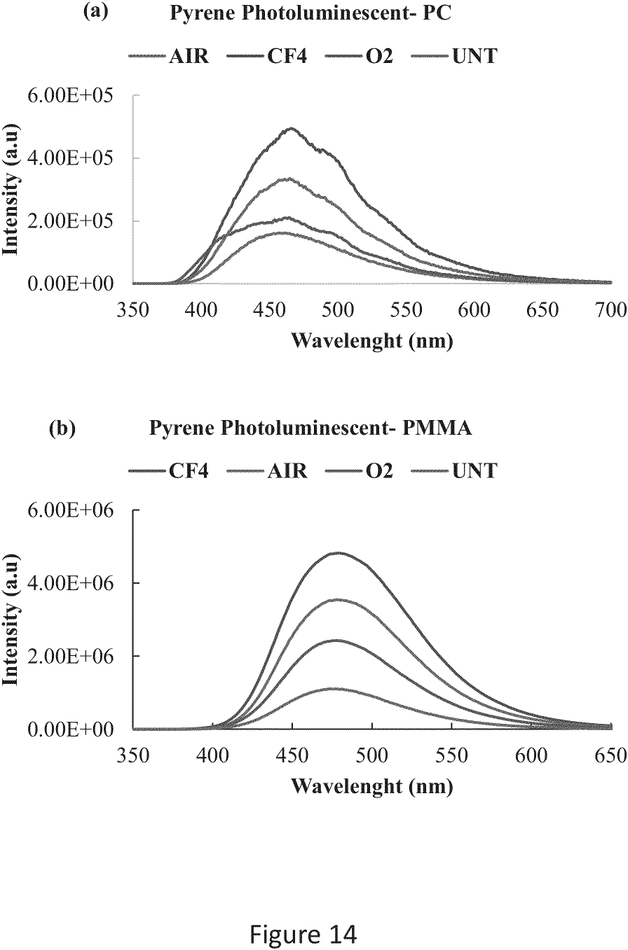

Pyrene as molecular fluorescent probe is by far the most often used dye material for various application due its fluorescence qualities and have been used throughout the past 50 years in the study of water-soluble polymers [37]. As hydrophobic pyrene units are attached to water-soluble polymers, both the polymers and the chromophores’ characteristics are changed. To assess the characteristics of surfactant micelles, phospholipid vesicles, and surfactant/polymer aggregates, the pyrene chromophore is usually used as a probe. Pyrene labels have been widely employed in research on the structural aspects of enzymes, DNA recognition, polymers and cellular components [38]. Therefore, to observe the change of pyrene attachment onto polymer surfaces that also change depending on plasma gas treatment, pyrenes solution in ethanol is used as probe. As mentioned previously, drop of pyrene solution was placed onto plasma treated and untreated polymer surfaces and after washing both surfaces the difference in fluorescent intensity attributed to the presence of pyrene molecules. For PC surfaces, after treated with CF₄ plasma under preferred conditions, the photoluminescence intensity increased from 3.23×10⁵ to 4.85×10⁵ in comparison to the untreated sample, as shown in FIG. 14(a). Moreover, after treated with O₂ plasma, its photoluminescence intensity decreased to 2.04×10⁵. Finally, after treatment with air plasma, intensity also decreased to 1.60×10⁵.

Untreated PMMA surface’s photoluminescence intensity found as 3.23×10⁶, while it is increased to 4.81×10⁶ after being treated with CF₄ plasma as shown in FIG. 14(b). Moreover, it is increased to 3.54×10⁶ and 2.42×10⁶ for air plasma and O₂ plasma treated surfaces, respectively. Results indicate that, for PC surfaces, the attachment of pyrene decreases with wettability since pyrene is a hydrophobic molecule. Moreover, for PMMA surface, all plasma types increased the attached amounts of pyrene, onto surface. However, treating the surface with CF₄ plasma shows the best result for pyrene attachment. The pyrene-introduced PMMA surface’s maximum photoluminescence intensity was found 10 times higher than pyrene-introduced PC surfaces. Therefore, the change in surface characteristics of polymers not only depend on the polymer nature and but also the used plasma gas to render desired functionality to the polymer surfaces. However, it is apparent that the surface features of polymeric materials can be readily tuned by using different plasma gasses that significant enhance and improve the biomedical applications.

### 4. Conclusions

The surface properties and functionalization of polymers play a role for a wide range of different applications. To effectively obtain surfaces with desired properties, surface design and functionalization must take into account the surface energy, wettability, adhesion, surface charges, and material topography. Consequently, low-pressure gas plasma treatments of air, O₂, CF₄, as utilized here, applied to PC and PMMA surfaces, and the desired surface functionalization was obtained. The CA values for PC surfaces of 109.04°±0.35° and of 105.76°±0.61° for PMMA surfaces, made more hydrophobic and less adhesive while lowering the surface free energies up to 11±0.87 mN/m and 12.11±1.53 mN/m, respectively upon CF₄ plasma treatment. With CA values of 29.34°±0.14° for PC and 43.99°±0.22° for PMMA surfaces, air plasma treated surfaces also showed more adhesive and hydrophilic behaviors. In addition, their surface free energies significantly increased up to 57.59±1.12 mN/m for PC surfaces and 62.13±1.15 mN/m for PMMA surfaces upon air plasma treatment. It was also found that surfaces treated with O₂ plasma had comparable wettability tendencies to those treated with air plasma.

The pattern masks size had an impact on surface functionality, although surface pattern shapes did not. The surface pattern of the masks in general also provide different contact angle, SFE and CAH values when treated with pure O₂, CF₄ and air. As the size of the surface pattern was increased for surfaces which treated with O₂ and air plasma, the sliding-off angle reduced in contrast to untreated surface. However, after exposed to CF₄ plasma, it was increased for PC and PMMA surfaces. Both surfaces, after being treated with any type of the plasma, wettability of the surface was stable against varying pH and NaCl concentrations.

The findings of the XPS examination revealed surface fluorination upon CF₄ plasma treatment and oxygen group functionalization of both PC and PMMA surfaces upon O₂ and air plasma treatment.

To the best of our knowledge, sequential multiple plasma gas treatments were applied to PC and PMMA surfaces for the first time with the study of this Example 1 and shown that the wettability of the surfaces increased remarkably. To sum up, superhydrophilic and hydrophobic PC and PMMA surfaces with a variable surface free energies and slide-off angles were generated, without using any chemicals and changing material main bulk characteristic, by using low-pressure plasma treatment and patterned masks with variable pattern sizes. These kinds of surfaces can be very useful for drug delivery, self-cleaning, less energy consumption systems depending on the application area. For example, to increase wettability or reduce adherence on polymeric surfaces of the implant for medical purposes, cold plasma treatment with various gaseous as versatile system can be readily available.

### References for Example 1

[1] A.J.T. Teo, A. Mishra, I. Park, Y.-J. Kim, W.-T. Park, Y.-J. Yoon, Polymeric Biomaterials for Medical Implants and Devices, ACS Biomater Sci Eng. 2 (2016) 454-472. https://doi.org/10.1021/acsbiomaterials.5b00429.

K. Shen, M.M. Maharbiz, Ceramic packaging in neural implants, J Neural Eng. 18 (2021) 025002. https://doi.org/10.1088/1741-2552/abd683.

M.F. Ulum, W. Caesarendra, R. Alavi, H. Hermawan, In-Vivo Corrosion Characterization and Assessment of Absorbable Metal Implants, Coatings. 9 (2019) 282. https://doi.org/10.3390/coatings9050282.

H.W. Toh, D.W.Y. Toong, J.C.K. Ng, V. Ow, S. Lu, L.P. Tan, P.E.H. Wong, S. Venkatraman, Y. Huang, H.Y. Ang, Polymer blends and polymer composites for cardiovascular implants, Eur Polym J. 146 (2021) 110249. https://doi.org/10.1016/j.eurpolymj.2020.110249.

S. Chatterjee, M. Saxena, D. Padmanabhan, M. Jayachandra, H.J. Pandya, Futuristic medical implants using bioresorbable materials and devices, Biosens Bioelectron. 142 (2019) 111489. https://doi.org/10.1016/j.bios.2019.111489.

L.. Rajapaksha, H.A.. Saumyadi, A.M.P.. Samarasekara, D.A.. Amarasinghe, L. Karunanayake, Development of cellulose based light weight polymer composites, in: 2017 Moratuwa Eng Res Conf, IEEE, 2017: pp. 182-186. https://doi.org/10.1109/MERCon.2017.7980478.

S.B. Kim, Y.J. Kim, T.L. Yoon, S.A. Park, I.H. Cho, E.J. Kim, I.A. Kim, J.-W. Shin, The characteristics of a hydroxyapatite-chitosan-PMMA bone cement, Biomaterials. 25 (2004) 5715-5723. https://doi.org/10.1016/j.biomaterials.2004.01.022.

J.H. Thean, A.A. Mcnab, Blepharoptosis in RGP and PMMA hard contact lens wearers, Clin Exp Optom. 87 (2004) 11-14. https://doi.org/10.1111/j.1444-0938.2004.tb03139.x.

S. Lee, M. Porter, S. Wasko, G. Lau, P.-Y. Chen, E.E. Novitskaya, A.P. Tomsia, A. Almutairi, M.A. Meyers, J. McKittrick, Potential Bone Replacement Materials Prepared by Two Methods, MRS Proc. 1418 (2012) mrsf11-1418-mm06-02. https://doi.org/10.1557/opl.2012.671.

D. Arcos, Bioactivity in glass/PMMA composites used as drug delivery system, Biomaterials. 22 (2001) 701-708. https://doi.org/10.1016/S0142-9612(00)00233-7.

X. Qi, Y. Ren, X. Wang, New advances in the biodegradation of Poly(lactic) acid, Int Biodeterior Biodegradation. 117 (2017) 215-223. https://doi.org/10.1016/j.ibiod.2017.01.010.

K. James, Small changes in polymer chemistry have a large effect on the bone-implant interface: evaluation of a series of degradable tyrosine-derived polycarbonates in bone defects, Biomaterials. 20 (1999) 2203-2212. https://doi.org/10.1016/S0142-9612(99)00151-9.

A.S. Alaboodi, S. Sivasankaran, Experimental design and investigation on the mechanical behavior of novel 3D printed biocompatibility polycarbonate scaffolds for medical applications, J Manuf Process. 35 (2018) 479-491. https://doi.org/10.1016/j.jmapro.2018.08.035.

D.R. Monteiro, L.F. Gorup, A.S. Takamiya, A.C. Ruvollo-Filho, E.R. de Camargo, D.B. Barbosa, The growing importance of materials that prevent microbial adhesion: antimicrobial effect of medical devices containing silver, Int J Antimicrob Agents. 34 (2009) 103-110. https://doi.org/10.1016/j.ijantimicag.2009.01.017.

I. Francolini, G. Donelli, Prevention and control of biofilm-based medical-device-related infections, FEMS Immunol Med Microbiol. 59 (2010) 227-238. https://doi.org/10.1111/j.1574-695X.2010.00665.x.

O.P. Abioye, C.A. Loto, O.S.I. Fayomi, Evaluation of Anti-biofouling Progresses in Marine Application, J Bio- Tribo-Corrosion. 5 (2019) 22. https://doi.org/10.1007/s40735-018-0213-5.

G. Franci, A. Falanga, S. Galdiero, L. Palomba, M. Rai, G. Morelli, M. Galdiero, Silver Nanoparticles as Potential Antibacterial Agents, Molecules. 20 (2015) 8856-8874. https://doi.org/10.3390/molecules20058856.

W. Pajerski, J. Duch, D. Ochonska, M. Golda-Cepa, M. Brzychczy-Wloch, A. Kotarba, Bacterial attachment to oxygen-functionalized graphenic surfaces, Mater Sci Eng C. 113 (2020) 110972. https://doi.org/10.1016/j.msec.2020.110972.

X. Yang, T.-H. Ku, S.K. Biswas, H. Yano, K. Abe, UV grafting: surface modification of cellulose nanofibers without the use of organic solvents, Green Chem. 21 (2019) 4619-4624. https://doi.org/10.1039/C9GC02035G.

M. Dhayal, M.R. Alexander, J.W. Bradley, The surface chemistry resulting from low-pressure plasma treatment of polystyrene: The effect of residual vessel bound oxygen, Appl Surf Sci. 252 (2006) 7957-7963. https://doi.org/10.1016/j.apsusc.2005.10.005.

Y. Li, Q. Bai, C. Yao, P. Zhang, R. Shen, H. Liu, L. Lu, Y. Jiang, X. Yuan, X. Miao, W. Han, Long-lasting antifogging mechanism for large-aperture optical surface in low-pressure air plasma in-situ treated, Appl Surf Sci. 581 (2022) 152358. https://doi.org/10.1016/j.apsusc.2021.152358.

T. Suni, K. Henttinen, I. Suni, J. Mäkinen, Effects of Plasma Activation on Hydrophilic Bonding of Si and SiO₂, J Electrochem Soc. 149 (2002) G348. https://doi.org/10.1149/1.1477209.

E. Vogli, D. Metzler, G.S. Oehrlein, Feasibility of atomic layer etching of polymer material based on sequential O 2 exposure and Ar low-pressure plasma-etching, Appl Phys Lett. 102 (2013) 253105. https://doi.org/10.1063/1.4812750.

A.L. Cordeiro, M. Nitschke, A. Janke, R. Helbig, F. D′Souza, G.T. Donnelly, P.R. Willemsen, C. Werner, Fluorination of poly(dimethylsiloxane) surfaces by low pressure CF4 plasma - physicochemical and antifouling properties, Express Polym Lett. 3 (2009) 70-83. https://doi.org/10.3144/expresspolymlett.2009.11.

G. Kalita, S. Adhikari, H.R. Aryal, D.C. Ghimre, R. Afre, T. Soga, M. Sharon, M. Umeno, Fluorination of multi-walled carbon nanotubes (MWNTs) via surface wave microwave (SW-MW) plasma treatment, Phys E Low-Dimensional Syst Nanostructures. 41 (2008) 299-303. https://doi.org/10.1016/j.physe.2008.07.015.

A. Al-Jumaili, K. Bazaka, M. Jacob, Retention of Antibacterial Activity in Geranium Plasma Polymer Thin Films, Nanomaterials. 7 (2017) 270. https://doi.org/10.3390/nano7090270.

Z. Liu, P. Chen, D. Han, F. Lu, Q. Yu, Z. Ding, Atmospheric air plasma treated PBO fibers: Wettability, adhesion and aging behaviors, Vacuum. 92 (2013) 13-19. https://doi.org/10.1016/j.vacuum.2012.11.002.

P. Deo, N. Deo, P. Somasundaran, A. Moscatelli, S. Jockusch, N.J. Turro, K.P. Ananthapadmanabhan, M.F. Ottaviani, Interactions of a Hydrophobically Modified Polymer with Oppositely Charged Surfactants, Langmuir. 23 (2007) 5906-5913. https://doi.org/10.1021/la063349u.

H.B. Eral, D.J.C.M. ‘t Mannetje, J.M. Oh, Contact angle hysteresis: a review of fundamentals and applications, Colloid Polym Sci. 291 (2013) 247-260. https://doi.org/10.1007/s00396-012-2796-6.

L. Gao, T.J. McCarthy, Contact Angle Hysteresis Explained, Langmuir. 22 (2006) 6234-6237. https://doi.org/10.1021/la060254j.

J. Wang, Y. Wu, Y. Cao, G. Li, Y. Liao, Influence of surface roughness on contact angle hysteresis and spreading work, Colloid Polym Sci. 298 (2020) 1107-1112. https://doi.org/10.1007/s00396-020-04680-x.

M. Boban, K. Golovin, B. Tobelmann, O. Gupte, J.M. Mabry, A. Tuteja, Smooth, All-Solid, Low-Hysteresis, Omniphobic Surfaces with Enhanced Mechanical Durability, ACS Appl Mater Interfaces. 10 (2018) 11406-11413. https://doi.org/10.1021/acsami.8b00521.

E. Proksch, pH in nature, humans and skin, J Dermatol. 45 (2018) 1044-1052. https://doi.org/10.1111/1346-8138.14489.

E. Lavy, D. Goldberger, M. Friedman, D. Steinberg, pH values and mineral content of saliva in different breeds of dogs, Isr J Vet Med. 67 (2012) 244-248.

D.F. Evans, G. Pye, R. Bramley, A.G. Clark, T.J. Dyson, J.D. Hardcastle, Measurement of gastrointestinal pH profiles in normal ambulant human subjects., Gut. 29 (1988) 1035-1041. https://doi.org/10.1136/gut.29.8.1035.

T. Hanawa, Metal ion release from metal implants, Mater Sci Eng C. 24 (2004) 745-752. https://doi.org/10.1016/j.msec.2004.08.018.

T.M. Figueira-Duarte, K. Müllen, Pyrene-Based Materials for Organic Electronics, Chem Rev. 111 (2011) 7260-7314. https://doi.org/10.1021/cr100428a.

L. Piñeiro, M. Novo, W. Al-Soufi, Fluorescence emission of pyrene in surfactant solutions, Adv Colloid Interface Sci. 215 (2015) 1-12. https://doi.org/10.1016/j.cis.2014.10.010.

The citation of any document is not to be construed as an admission that it is prior art with respect to the present invention.

### Example 2

### 1. Introduction to Example 2

Because of their relatively low production costs and the desired physical and chemical characteristics, such as a high strength-to-weight ratio and corrosion resistance, plastics or specifically polymers are becoming more important as commodity materials and are gradually replacing traditional engineering materials, such as woods and metals [1]. Innumerable applications in the automotive, aerospace, medical, and other fields need the use of polymeric materials with enhanced characteristics [2]. Although most polymers have outstanding properties, they also have some shortcomings, such as low surface energy and poor wettability. For example, materials with low surface energy are difficult to coat or get a good bonding with adhesives. As a result, there is an increased need for polymers with enhanced surface characteristics, such as wettability, printability, adaptability, and biocompatibility.

Polymeric materials are chosen and created for their bulk qualities; yet the inert nature of most polymers causes difficulties for several applications. Altering these polymers’ surfaces to change their chemistry and customize their interaction for the intended use is an effort to solve this challenge without altering their bulk properties. Exposing polymer surface to plasma to modify its surface chemistry is a typical advantageous strategy [3]. This technique is used to modify the adhesion qualities of a wide range of polymers, either to increase their adhesive capabilities by rendering its surface more hydrophilic, or by decreasing its adhesive properties by making its surface more hydrophobic. The ability to modify the surface without changing the bulk characteristics of polymers is considered an advantageous technology for the surface modification hence enabling coating of a variety of materials. For example, to determine whether a material can be used in biomedical applications, adhesion characteristics and the wetting nature, namely a hydrophilic or hydrophobic character, must be taken into account. An implant with a high degree of hydrophobicity, for instance, is more inert and less likely to promote blood coagulation than one made up of a hydrophilic material [4-6]. Plasma treatment is a speedy procedure as compared to other treatment methods because it introduces new chemical groups into the surface layers of a polymer material, such as carboxylic, hydroxyl, amine, or aldehyde groups within a few seconds without using any wet chemistries [1]. The plasma treatment procedure is reproduceable and uses a minimal amount of energy and chemicals [7, 8] hence no waste is generated. As no solvents are needed, the procedure is considered to be dry, clean, and environmentally friendly [9]. Additional benefits of plasma processes are their simplicity, affordability, and high efficiency [1, 9, 10].

This Example 2 focused on the plasma treatment of commercially available low-density polyethylene (LDPE) and medical grade silicone (polydimethylsiloxane/PDMS) sheets. The treatment mainly comprised functionalization/activation of the materials but is also coupled with a slight degree of etching that occurs during the treatment process depending on the applied power to generate plasma and exposure time. Different gases, e.g., carbon tetrafluoride (CF₄), oxygen (O₂), and air were utilized to study the changes in the surface properties of LDPE and silicone. Water contact angle (CA), surface free energy (SFE), and contact angle hysteresis (CAH) measurements of the LDPE and silicone, pre- and post-plasma treatment, were compared. The effects of the treatment in diverse environments, e.g., different pHs and NaCl concentrations were assessed in addition to the water contact angle. Additionally, the qualities of its protein adhesion were examined by measuring the contact angle upon contacting the surface of the polymers with different concentrations of bovine serum albumin (BSA). Aging studies, where the contact angle and surface free energy were assessed over a predetermined time, were used to address the treatment’s stability. Additionally, the degree of etching on the surface of the materials and its change in topography were determined via atomic force microscopy (AFM) and scanning electron microscopy (SEM) analysis. Fourier transform infrared radiation spectroscopy-attenuated total reflectance (FTIR-ATR), and X-ray photoelectron spectroscopy (XPS) were used to verify the successful functionalization of the plasma treatments. Finally, LDPE and silicone were treated with multiple successive gas plasma treatment up to 6 times to achieve a higher flexibility in the resulting wettability of the samples.

### 2. Materials and Methods

### 2.1 Materials

Silicone sheets (medical grade silicone sheet, 0.062-inch thickness) were purchased from American Rubber Products, USA. Low density polyethylene sheets (0.031-inch thickness) were purchased from Professional Plastics, USA. Microscope slides (7 cm × 2 cm) were purchased from AmScope, USA. Oxygen (O₂, 99.7%) and carbon tetrafluoride (CF₄, 99.9%) were purchased from Airgas, Tampa, USA. Ambient air that was used for the air plasma treatment of the polymer samples. Diiodomethane was purchased from Thermo Fisher Scientific, USA. Natrium chloride (NaCl, 99%⁺), potassium chloride (KCI, 99%⁺), sodium phosphate dibasic, potassium phosphate monobasic, and bovine serum albumin (BSA) were all purchased by Thermo Fisher Scientific, USA.

### 2.2 Preparation of Polyethylene and Silicone Sheets

For the plasma treatment the sheets were cut in strips (7 cm × 2 cm), wiped gently with ethanol, and put onto microscope slides using double sided scotch tape to assure a flat surface for the contact angle measurements. The prepared glass slides with the specimen were then placed into the plasma chamber for the corresponding plasma treatment.

### Plasma Treatment

The surface modification of the sheets was performed by using a low-pressure 13.56 MHz RF (radio frequency) plasma generator instrument (Diener Electronic Femto AR-PC, Germany). To ensure a uniform gas environment, the plasma generator ran with an empty chamber before each treatment for at least 15 minutes to clean the chamber of any residue gas from previous runs. The pressure during the irradiation was kept constant for all experiments at 0.3 mbar. To evaluate the preferred process power for each gas, the samples were first irradiated for 2 minutes with varying power levels of 30 W, 60 W, 90 W, 150 W, and 250 W. The samples were placed 8 cm distance from the electrode. After treatment, the water contact angle was measured. For oxygen and air plasma irradiation, the power level with the lowest contact angle was set as the preferred process power. For the irradiation with CF₄ plasma, the highest contact angle was deemed as the preferred power level. To determine the preferred irradiation time, the predetermined power was set, and the irradiation times of 2 minutes, 5 minutes, 10 minutes, 15 minutes, 20 minutes were carried out. The same contact angle conditions were set to evaluate the preferred process time for each plasma gas. Furthermore, consecutive plasma treatments with multiple plasma gases were studied to increase the effectiveness of the treatment. The first treatment was run at the determined preferred parameters, whereas the following treatments were run for 2 minutes at the predetermined preferred process power.

### 2.3 Preparation of pH, NaCl, and BSA Solutions

Different pH solutions were prepared using 1 M NaOH and HCl solutions. The NaCl solutions at various concentrations were prepared by dissolving sodium chloride in DI water at various amounts e.g., 0.001 M, 0.01 M, 0.1 M, and 1 M. The BSA solution was also prepared at 0.001 M, 0.01 M, 0.1 M, 1 M, 10 M, and 100 M in a phosphate-buffered saline (PBS) solution with a pH of 7.4, to evaluate the plasma treatment’s effects on protein adhesion. The PBS solution was made by combining 800 mL of DI water with 8 g of NaCl, 0.2 g of KCI, 1.44 g of sodium phosphate dibasic, and 0.245 g of potassium phosphate monobasic. Finally, the pH was adjusted to 7.4 and distilled water was added until a volume of 1 L was reached.

### 2.4 Characterization of LDPE and Silicone Before and After Plasma Treatments

The wetting properties the polymers were analyzed by contact angle and surface free energy measurements using an optical tensiometer (Biolin Scientific, Attension Theta Flex, USA) at the determined preferred process parameters for the plasma treatment. The sessile drop method was utilized by using 6 µL volume of water for each CA measurement at 22° C. To decrease uncertainty, each CA measurement consists of the average of 5 measurements. The SFE was measured utilizing the Owen, Wendt, Rabel and Kaelble (OWRK) method with water as the polar liquid and diiodomethane was used as the dispersive liquid with each point representing the average of 3 different measurements. Each measurement used 6 µL of measuring liquid at the same conditions as the CA measurements. Furthermore, the contact angle hysteresis was studied with the tilting method, where a 6 µL drop was placed onto the sample and the stage was tilted until sliding of the droplet occurred. The SFE was measured after storage in air, DI water, and vacuum (0.3 bar in a desiccant) for 1 hour, 3 hours, 24 hours, 96 hours, and 168 hours. For the storage in water, the specimen were blow dried using dry air before taking the measurement. The surface roughness and the topography after and before the treatment were analyzed by scanning electron microscopy (SEM, Hitachi S-800, Japan) and atomic force microscopy (AFM, Veeco Dimension 3000 Atomic Force Microscope, USA). For the SEM analysis, the samples were precoated with gold and palladium nanoparticles for 3 minutes. The FT-IR-ATR spectra was collected using a (Nicolet iS50 FT-IR Spectrometer, USA) instrument. X-ray photoelectron spectroscopy (XPS, PHI model 5000 LS XPS system, USA) was utilized to prove the existence of functionals groups on the surface after the treatment. A monochromatic Al Kα (photon energy = 1486.6 eV) X-ray source at a power of 350W was used. The beam irradiated the sample surface with a 1×3.5 mm ellipse cross section and a scan area of 3.5 mm². The incident angle was set to 37° with a takeoff angle of 45°. The photoelectrons were analyzed with a spherical capacitance analyzer at a pass energy of 8.9 eV while the scan time for each step was set to 40 seconds.

### 3. Results and Discussion

### 3.1 Contact Angle Analysis

To investigate the wetting nature of the samples before and after plasma irradiation, the CA was measured utilizing the sessile drop method. The CA measurement is a quick and easy method to provide insight on the hydrophilicity of the surface, it is one of the most commonly used methods for surface characterization. Water was used as the measuring liquid with a drop size of 6 µL on the polymer sample and the measurement was carried out immediately after the plasma treatment of the polymer samples.

Both the air plasma as well as the oxygen plasma modified the surface of the LDPE and silicone, turning them more hydrophilic. In both cases, it is assumed that the energetic electrons, positively and negatively charges ions and radicals that are formed during the plasma as well as the UV radiation, hit the surface of the samples resulting in slight etching and breakdown of weak bonds [11]. As a result, the atoms on the surface are dissociated from their bonds and the polymer chains with their broken bonds react with the oxygen radicals in the plasma forming new oxygen containing functional groups on the surface. Inevitably, this leads to the increase in wettability due to the change in polarity. In contrast to the oxygen plasma, where oxygen with a purity of 99.70% was used, the air plasma used ambient air with assumed 21% oxygen content. This may result in a lower change of the wettability, even though some literature states that an optimized mix of nitrogen and oxygen could facilitate the introduction of reactive groups such as amines and carboxyl groups [11]. The nitrogen causes a higher degree of etching, increasing the surface area of the material and giving the oxygen more active sites to bond. However, if the oxygen content of the gas is too low, this could result in a lower amount of oxygen functionalization.

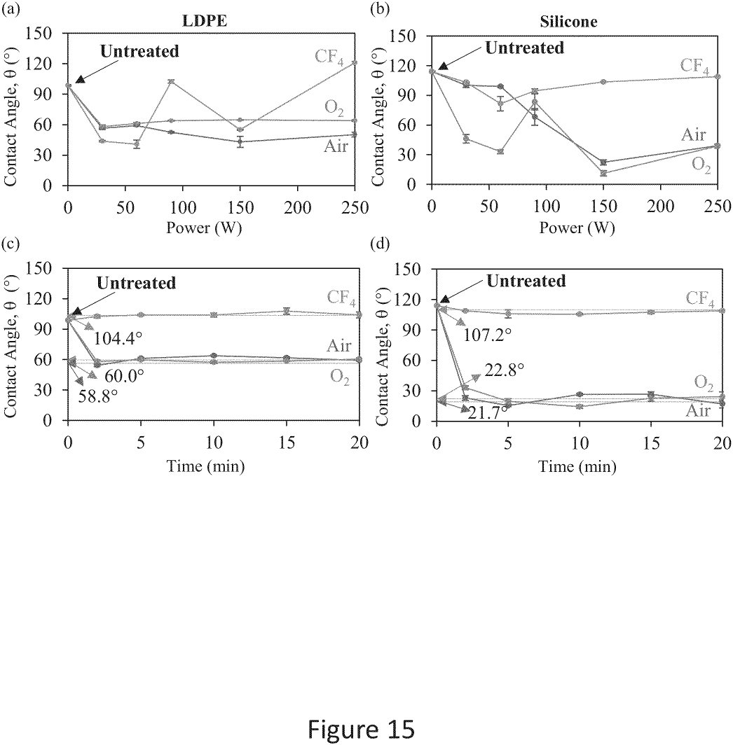

To determine the preferred power level of the treatment, all samples ran at 0.3 mbar for 2 minutes with varying power as illustrated in FIGS. 15(a) and (b). For the oxygen and air plasma, the lowest CA was chosen as the preferred parameters and for the CF₄ plasma treated samples, the highest CA value was chosen as the preferred conditions. The reason for the sudden increase in contact angle after increasing the power level is assumed to be due to the fact, that the degree of etching also increases with the increase in power. This causes the already functionalized top layer to be etched away, leaving a “fresh” unbonded surface. Then, the remaining irradiation time seems to be not enough to bond the free radicals in the plasma with the unbonded molecules and atoms on the surface of the specimen, which then reacts with the environment, resulting in a lower level of oxygen containing functional groups on the surface. So, to minimize the etching on the surface, the first lowest/highest CA value was chosen, before the change of slope.

For the LDPE the preferred power levels was determined at 90 W, 150 W, and 30 W for CF₄, air, and O₂, respectively. The silicone showed the preferred CA for the above-mentioned criteria at 250 W, 150 W, and 60 W for CF₄, air, and O₂, respectively. With these determined power levels, the treatments were run again, this time with varying irradiation times resulting in 15 minutes, 2 minutes, and 10 minutes for LDPE and 2 minutes, 5 minutes, and 10 minutes for silicone for CF₄, air, and O₂ as illustrated in FIGS. 15(c) and (d), respectively. The determined preferred process time and process power with their correlating CA results are given in Table 4. It appears that the variation of plasma power has a stronger effect on the CA values than irradiation time. After determining the preferred power, the conflict between ablation/etching and functionalization becomes discernible [12-14].

TABLE 4

Results of CA optimization process

| Varying Power | | | | Varying Time | | | |
|---|---|---|---|---|---|---|---|
| Material | Gas | Power [W] | CA [°] | Material | Gas | Time [min] | CA [°] |
| LDPE | CF₄ | 90 | 102.45 ± 1.54 | LDPE | CF₄ | 15 | 107.76 ± 3.12 |
| LDPE | Air | 150 | 43.02 ± 5.41 | LDPE | Air | 2 | 54.24 ± 1.09 |
| LDPE | O₂ | 30 | 58.10 ± 1.67 | LDPE | O₂ | 10 | 57.35 ± 1.07 |
| Silicone | CF₄ | 250 | 108.87 ± 0.61 | Silicone | CF₄ | 2 | 108.87 ± 0.61 |
| Silicone | Air | 150 | 22.24 ± 2.53 | Silicone | Air | 5 | 15.33 ± 0.83 |
| Silicone | O₂ | 60 | 33.01 ± 1.97 | Silicone | O₂ | 10 | 14.34 ± 1.63 |

The change in wettability indicates the incorporation of oxygen containing functional groups in the case of air and oxygen plasma, and fluorine containing functional groups for the CF₄ plasma treatment onto the surface of the material. However, the etching may have caused a slight change in topography of the materials, causing a decrease or increase in contact angle. To evaluate the functional groups and etching caused by the treatment, FT-IR, XPS as well as SEM and AFM techniques are used to evaluate these changes and will be discussed later in this article.

### 3.2 Contact Angle Analysis in Different Environments

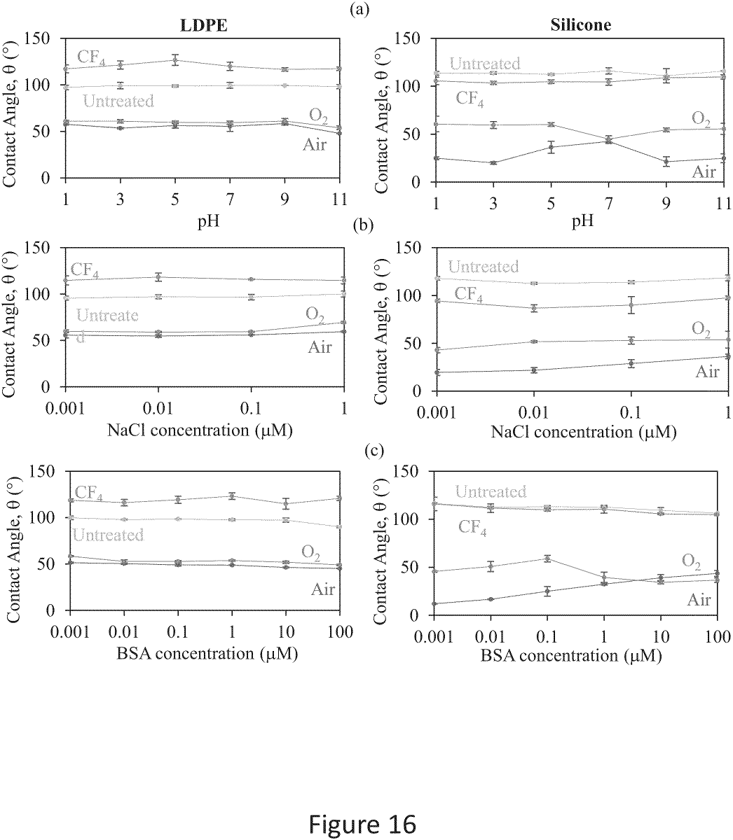

Furthermore, to evaluate the modified wettability of LDPE and silicone for different environments, pH, BSA and NaCl concentrations, the contact angle was measured, and results are presented in FIG. 16a, 16b) and 16c),) respectively. The results show that LDPE shows more stable surface properties compared to silicone after treatments. However, the small changes in the contact angle around pH 7, and BSA concertation >0.1 M for air and oxygen plasma treated silicone should be considered in the biomedical use such as implant that might slightly change the surface properties of the materials, which could have some importance.

### 3.3 Surface Free Energy Analysis

The characterization of the surface of a solid material is of utmost importance in the field of product development and research. The surface free energy (SFE) of a material gives information on the wettability and its interactions with the contact material. It can be used to determine the success of a painting or coating, but it also reveals information about application of biomaterials e.g., to predict how a material behaves when placed in a human body (transplants) or in contact with alive environment.

The SFE of the LDPE and silicone before and after plasma gas treatments were calculated using the Owen, Wendt, Rabel and Kaelble (OWRK) method with DI water as the polar liquid and diiodomethane as the dispersive liquid using equation 1,

$$\sqrt{{γ}_{s v}^{d} {γ}_{l v}^{d}} + \sqrt{{γ}_{s v}^{p} {γ}_{l v}^{p}} = 0.5 + {γ}_{l v} \left(1 + c o s \left({θ}_{Y}\right)\right) \qquad \text{(1)}$$

where γ_{sᵥ} is the surface tension of the solid, γ_{lᵥ}represents the surface tension of the liquid, the superscript “d” and “p” stand for the dispersive and polar component respectively, and θ_{ʏ} is the CA of the liquid [15]. The surface tension of most liquids is already researched and tabulated, the CA can easily be measured through an optical tensiometer. This leaves the surface tension of the solid, also called the SFE, which is then easily acquired by using two liquid with known dispersive and polar components such as DI water

$$\left({γ}_{l v}^{d} = 18.7 \frac{m N}{m} , {γ}_{l v}^{p} = 53.6 \frac{m N}{m}\right)$$

[16] and diiodomethane

$$\left({γ}_{l v}^{d} = 50.8 \frac{m N}{m} , {γ}_{l v}^{p} = 0 \frac{m N}{m}\right)$$

[17,18].

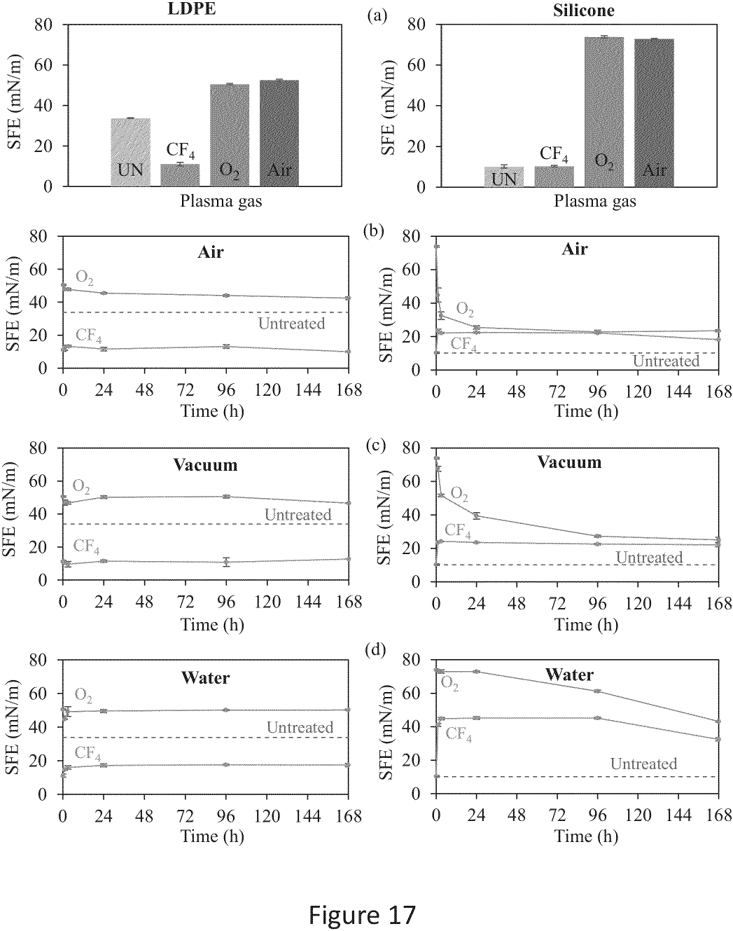

The calculations were done by measuring the CA of water and diiodomethane with the tensiometer, the program then utilized the measurements to calculate the SFE. The SFE was calculated immediately after plasma treatment and 1 hour, 3 hours, 24 hours, 96 hours, and 168 hours post treatment to evaluate the stability of the treatment. This was done in different storing environments, namely air, vacuum, and storage in DI water. The results taken immediately after treatment indicate that the SFE of the air and oxygen treated samples are in the same range, therefore the evaluation over time was done for the CF₄ and O₂ plasma treated specimen. The results are presented in FIGS. 17, wherein (a) shows the SFE immediately after treatment, (b) air stored, (c) vacuum stored, and (d) water stored.

The aging in air resulted in a partially quick hydrophobic recovery for the silicone samples within the first 24 hours. For silicone, the SFE stabilized at around 20 mN/m for both treatments, the LDPE samples stabilized at around 10 mN/m for the CF₄ plasma treatment and 45 mN/m for the oxygen plasma treatment. The aging in the desiccant under a low vacuum seems to slow down the recovery for the treated silicone samples, increasing the time to reach a lower stable state for the O₂ treatment to around 96 hours. However, for the CF₄, air, and O₂ plasma treated LDPE, it seems like the storing condition has little to no effect since a stable SFE is already reached after 24 hours. The storage in DI water also did not help to prevent the partial recovery of the treated LDPE specimen but significantly slowed down the recovery of the oxygen treated silicone. Even after 168 hours, the SFE remained at around 45 mN/m. The recovery of the intrinsic hydrophobic character of polymers after plasma treatment is well known, and mostly ascribed to three phenomena, namely the diffusion of the newly introduced functional groups into the bulk of the polymer, elimination of the functional groups due to chemical reactions on the surface, and surface reorientation of functional groups to minimize the SFE [19-22]. Most of the time, the diffusion is the determining factor to minimize the SFE. For silicone, some literature suggested that a chemical reaction on the surface with air, namely the condensation of silanols, increase the rate of recovery [20]. Compared to LDPE, the recovery of silicone is more noticeable, this may be due to the flexible siloxane bonds (Si-O) that act as the backbone in the silicone. These siloxane bonds are bonded to methyl groups (-CH₃) that are known for their low critical surface tension and therefore the cause for the intrinsic hydrophobic character of silicone. The flexible siloxane backbone allows the methyl groups to reorient to the surface to minimize the SFE [23]. After 168 hours of aging, the highest SFE values for the oxygen treated polymers are demonstrated when stored in water, especially for silicone the recovery was slowed down significantly. On the other hand, the CF₄ plasma treated samples showed better results when stored in air or in a low vacuum in a desiccant.

### 3.4 Contact Angle Hysteresis (CAH) Measurements

Besides contact angle measurements, contact angle hysteresis (CAH) was utilized to evaluate the effect of the plasma treatment in regard to the energy that is necessary to move a water droplet from its initial place or location. Usually, CAH is determined and used to evaluate the surface roughness or heterogeneity, but in this Example 2, it is used to determine the angle that is needed for a set volume of DI water to be moved during tilting [24]. For the CAH, the stage on which the sample is placed is being tilted, causing the droplet to deform due to the gravitational force. The higher CA is called the advancing contact angle θₐ, whereas the lower contact angle is named the receding contact angle θᵣ. The difference between these two angles is called the contact angle hysteresis and the angle at which the stage is tilted is called the cradle angle θc. The weight of the droplet is pushed towards one side with increasing θ_{c}, resulting in an increase of the θₐ and decrease of θᵣ until the equilibrium is broken, at which the droplet flows down. Table 5 shows the results of the CAH measurement.

TABLE 5

CAH results for untreated and plasma treated LDPE and silicone

| | θₐ (°) | θᵣ (°) | θₕ (°) | θ_{c} (°) |
|---|---|---|---|---|
| LDPE UN | 113.69±1.16 | 81.09±1.29 | 32.60±1.14 | 38.09±0.68 |
| LDPE Air | 66.22±3.12 | 27.46±2.63 | 38.75±0.50 | 37.04±2.89 |
| LDPE CF₄ | 152.44±7.25 | 92.56±1.94 | 59.88±6.37 | 66.59±2.58 |
| LDPE O₂ | 70.49±1.36 | 25.25±0.20 | 45.25±1.17 | 46.82±0.31 |
| Silicone UN | 117.29±1.97 | 89.54±0.85 | 27.75±1.38 | 57.24±1.65 |
| Silicone Air | N.A. | N.A. | N.A. | ~70 |
| Silicone CF₄ | 123.5±1.46 | 90.47±1.10 | 33.03±6.34 | >90 |
| Silicone O₂ | N.A. | N.A. | N.A. | ~30 |

The hydrophobic samples, namely the CF₄ plasma treated specimens demonstrated the highest θₐ and θ_{c} values, which is mainly due to their high water-repellent characteristics. In contrast, the hydrophilic samples show lower θₐ. This can be explained by the fact that the droplet spreads more in the case of the hydrophilic samples during the experiment, therefore less water builds up with increasing θ_{c} on one side, which reduces the weight that would pull down the droplet. In case for the hydrophobic specimen the liquid is in a more focused space, resulting in a significantly higher θₐ. For the silicone samples that were treated with oxygen and air plasma, the hydrophilic properties were so strong that θₐ and θᵣ could not be picked up by the camera. However, the angle at which the spread droplet started to move was registered during the tilting process. The energy that is necessary to move the droplet can be affected by the repulsive or attractive forces between the water molecules and the surface composition which is modified during the treatment. At the same time, the surface roughness has a significant effect on the CAH measurements, as a consequence, any assumptions on the roughness caused by the etching during the treatment could also be attributed to newly introduced functional groups on the surface. Nevertheless, when looking at the cradle angle it appears that the air plasma treated silicone specimen have a higher surface roughness with around 70° compared to the O₂ treated one which demonstrate a value of around 30°. Since both treatments functionalize the surface with oxygen groups, the roughness would be the dominant factor. On the other hand, even after reaching 90° tilt angle the droplet on the CF₄ treated silicone sample does not move. The etching and the resulting surface roughness and its effects will be discussed further below.

### 3.5 Surface Morphology and Topography

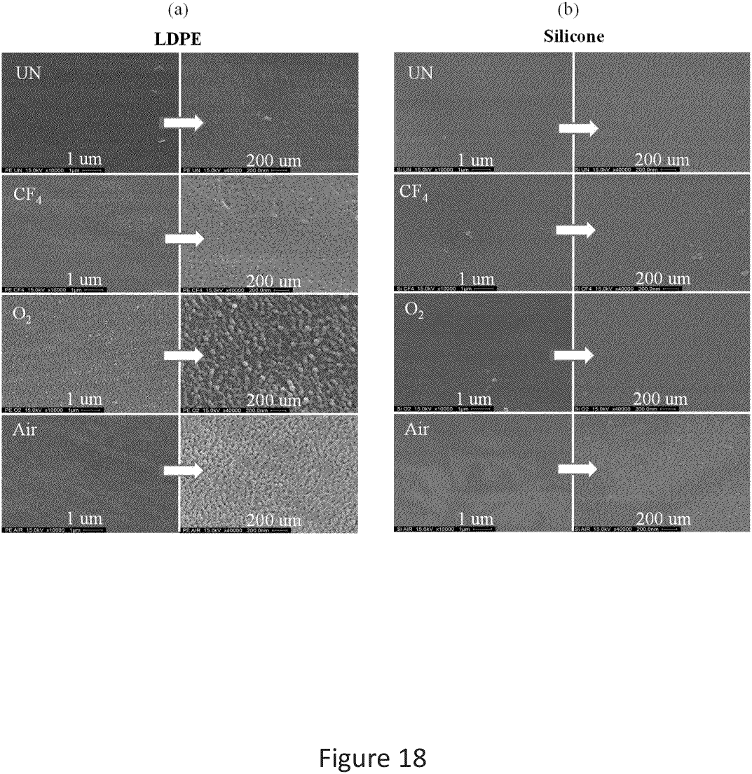

The SEM images in FIGS. 18 are used to observe the effects of the treatment on the topography of the samples. The images taken for LDPE presented in FIG. 18(a) clearly show the etching caused by the plasma treatments. The etching is not focused in one direction, rather the bombardment by electrons, positively and negatively charges ions and radicals, results in an isotropic etching, forming the spherical shapes seen for the images taken of the treated LDPE samples. This type of etching is also referred as reactive ion etching. However, due to the fact that the introduced gases react with the compounds that are made volatile during the process, the term ion-assisted chemical vapor etching is more fit. This type of etching increases the overall surface area that is available for interactions due to its increased active sites. The resulting increased adhesion properties by the enhanced surface area and the introduced functional groups are often used to bind biomolecules such as collagen onto the otherwise inert surface of silicone [25]. However, this change in topography is affecting the CA measurements, which necessitates a different kind of characterization for the functional groups. In contrast to the LDPE, the SEM images taken of the silicone surface shown in FIG. 18(b)are not as affected by the plasma treatments. All of the treatments cause a very small degree of etching, more notable in the case of the CF₄ plasma treatment and definitely more intense in case of the air plasma treatment. The latter is also coupled with the formation of some cracks on the surface, which could have caused the lower CA in comparison to the O₂ plasma treated counterpart. In general, it seems that the etching is predominant for LDPE rather than silicone. This can be explained by different bonding energies of chemical functional groups in the materials.

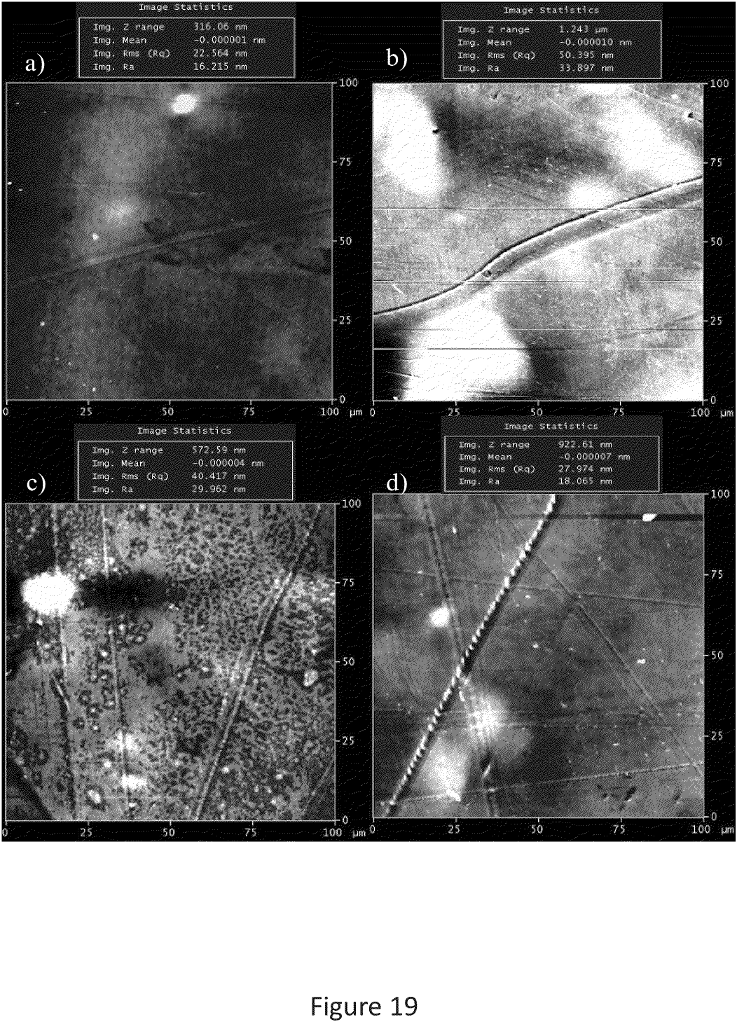

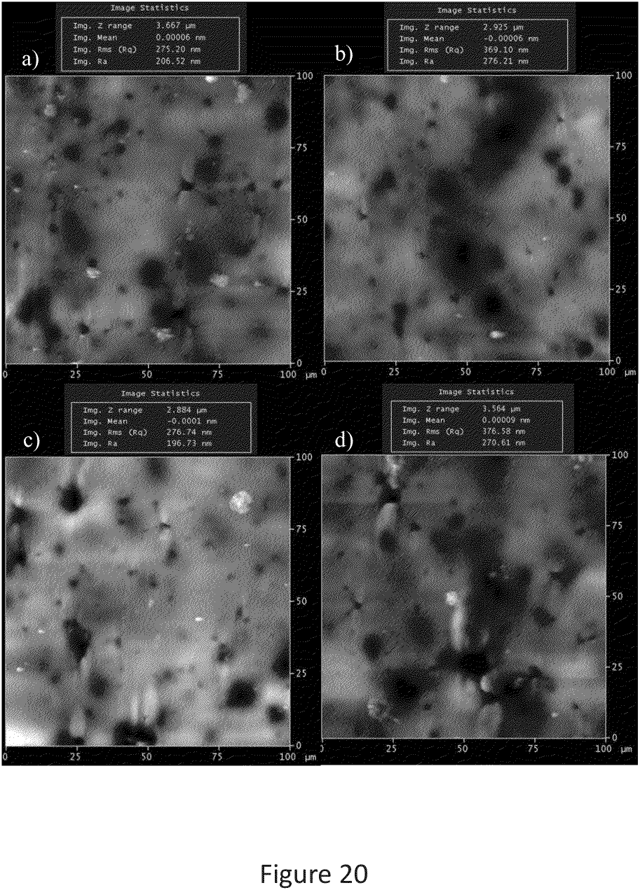

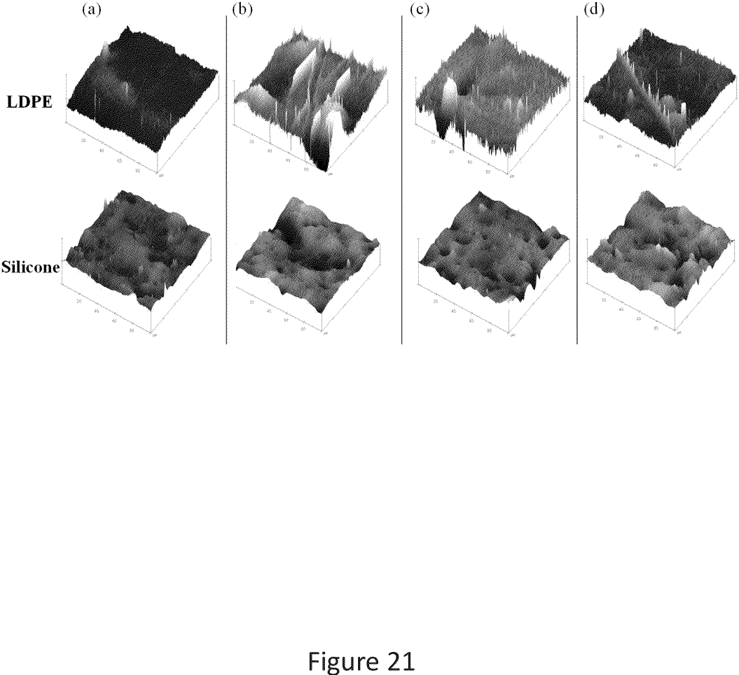

AFM in tapping mode was used to conduct additional studies on the topography. It was utilized to get 3D images of the specimens as well as a surface roughness analysis that are given in FIGS. 19 and FIGS. 20. The attained 3D images of the surface of the specimens are shown in FIGS. 21. For the LDPE samples, the air plasma treatment yields the lowest results in regard to the surface roughness, whereas the O₂ and CF₄ plasma gas treatment seem to result in a higher degree of etching. The surface roughness analysis measured an average surface roughness of 16.2 nm, 33.9 nm, 29.9 nm, 18.1 nm for the untreated, CF₄, O₂, and air plasma treated LDPE samples, respectively. Since the surface roughness is the deviation that is present on the surface, it means that the average height of the untreated sample is the lowest, followed by the air treated and oxygen treated sample, and lastly the CF₄ treated sample. Even though a high surface roughness is often undesirable, since it is associated with a high friction coefficient, and is a starting point for cracks and corrosion, it also promotes adhesion which is often needed for coatings and paints. So, depending on the application and the coating material, the CF₄ treated sample may be the preferred treatment gas. Furthermore, since the CF₄ plasma treatment also introduces fluorine containing groups onto the surface and turns it more hydrophobic, thicker coating are more easily achievable. This is due to the synergy of the promoted adhesion properties from the etching, and the hydrophobic characteristics of the modified surface. On the other hand, the air treated sample demonstrated a low surface roughness, in addition to its hydrophilic character, thin films of coatings can be more easily achieved. These claims are also supported by the CAH results, where the highest θc was achieved for the CF₄ treated sample, which had a hydrophobic character and the highest surface roughness. In contrast, the untreated and air treated specimen had the lowest surface roughness.

Compared to the surface roughness analysis of the LDPE specimen, the silicone samples show a higher average surface roughness with 206.5 nm, 276.2 nm, 196.7 nm, and 270.1 nm for the untreated, CF₄, O₂, and air treated surfaces, respectively. The “pitfalls” or cracks that can be seen in the 3D images in FIGS. 21 or in the surface roughness analysis in FIGS. 20, are the reason for these rather high values. However, when compared to the silicone control these topographical defects are intrinsically present in the material and not caused by the treatment. Nevertheless, the treatment causes a slight degree of etching, which effects can be observed in the CA and CAH measurements. The fluorination and etching from the CF₄ plasma treatment enhances the adhesive forces so much, that even after reaching 90° tilt angle in the CAH measurements the droplet does not slide. In case for the O₂ treated sample, the angle at which sliding occurs, decreased due to the increased wettability and for the air treatment it increases which indicates that the etching has a stronger effect than the functionalization. The caused modification, namely the etching and functionalization, could find potential use in biomedical applications where silicone is already integrated. Contact lenses, catheters, and membranes for example have great synergy with the increased wettability where it could promote the fluidic coating of the material and decreases friction [26]. Furthermore, the hydrophobic modification can help prevent the deposition of a plasma protein layer on implants, reducing the risk of thrombosis. Since the surface interactions of the implants with its surrounding determines the adhesion, activation and development of platelets, coagulation, cell attachment and protein deposition, plasma treating the implant before its use can help prevent various problems that occur post operation [26].

### 3.6 FT-IR - ATR Analysis of LDPE and Silicone Surfaces

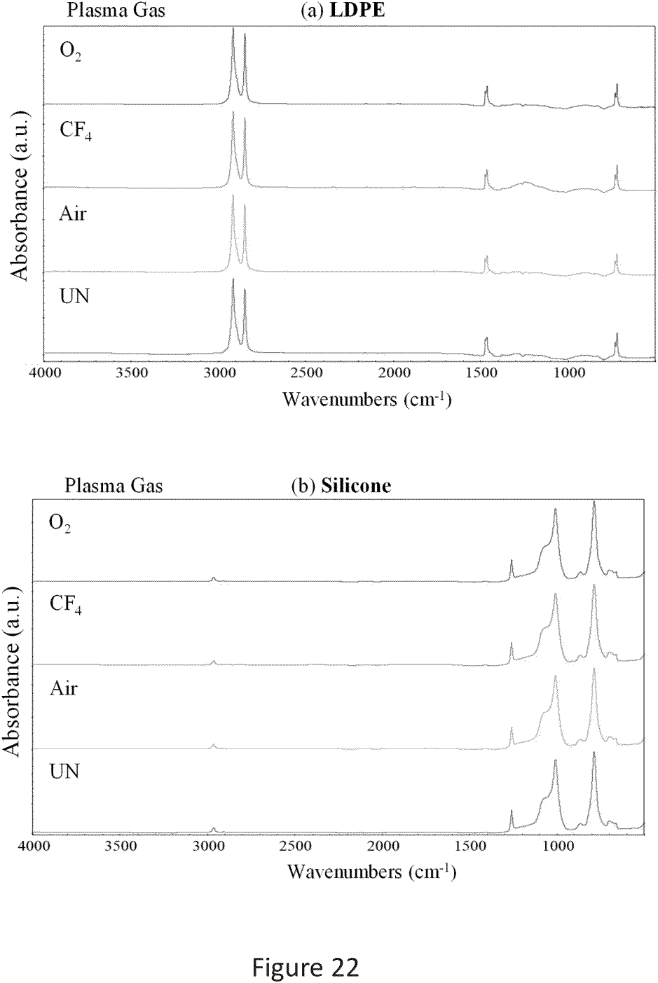

A first approach was made to prove that the treatment introduced new functional groups onto the surface of the LDPE and silicone sheets upon plasma treatments and determine their existence utilizing FT-IR-ATR. The FT-IR spectrum of LDPE and silicone with different gas plasma treatments and untreated sample as the reference in the range of 500 - 4000 cm⁻¹ were illustrated in FIGS. 22(a) and (b), respectively. The IR spectra of silicone is very similar to the already reported ones in the literature [14, 27, 28]. The peak at around 2962 cm⁻¹ is accredited to the C-H stretching for CH₃, while the peaks at 1260 cm⁻¹ and 864 cm⁻¹ are assigned to the bending and rocking vibration of Si-CH₃. The absorption peaks between 1000 and 1100 cm⁻¹ are characteristic for the stretching vibration of Si-O-Si and the intense peak at around 790 cm⁻¹ is caused by Si-(CH₃)₂

The FT-IR spectra for LDPE also does not differ much from previously reported literature [29-31]. The peaks at 2917 and 2852 cm⁻¹ are assigned to the asymmetric and symmetric C-H stretching vibrations of CH₂ respectively, which decreased in intensity for the CF₄ plasma treated sample. The other two peaks that align with the literature are the peaks at 1466 cm⁻¹, which is due to the C-H deformation vibrations and at 720 cm⁻¹ which is caused by the rocking vibration in —(CH₂)ₙ—repeating units LDPE. The only dissimilarity that was observed is the broad peak between 1000 and 1400 cm⁻¹ for the CF₄ plasma treated sample is due to C-F stretching caused by the introduction of fluoride containing functional groups.

The ratio between the altered depth and the level identified by FT-IR-ATR is approximately parts per thousand, which explains why the functional groups are not visible in the FT-IR-ATR spectra. In comparison to the substrate, the signal of the newly generated functional groups in the modification layer is significantly less. The FT-IR - ATR approach makes it such that the radiation only needs to travel a few microns into the sample before it is reflected into the optical element; however, the depth of the samples’ modified layers is just a few nanometers [28]. Therefore, XPS analysis needed to gain a better understanding of the introduction of the new functional groups upon plasma treatments.

### 3.7 XPS Analysis of LDPE and Silicone Upon Plasma Treatments

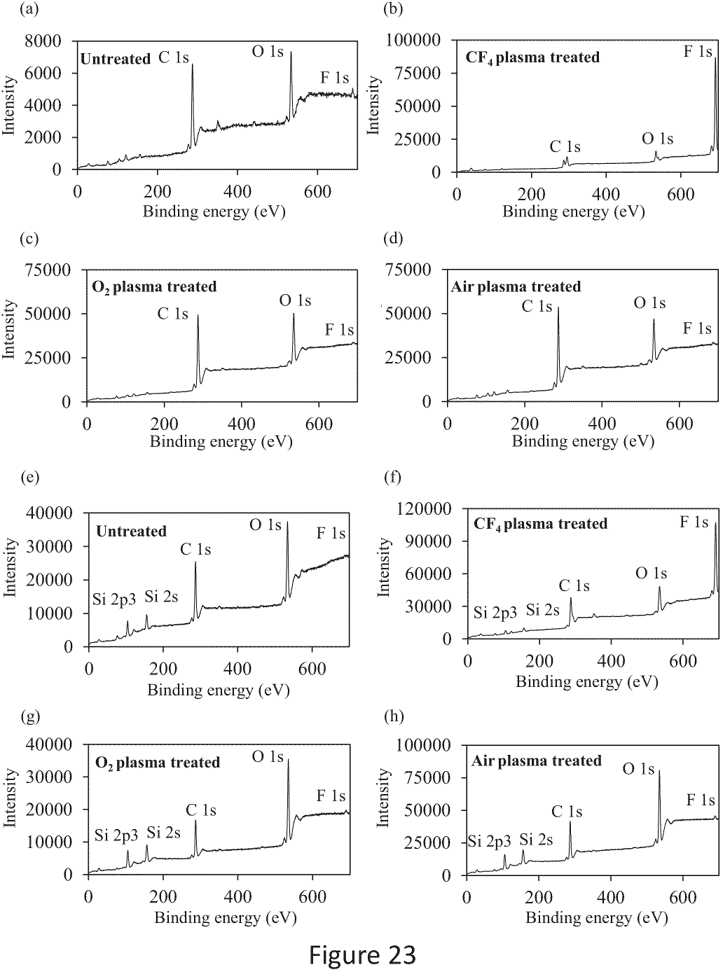

The results of XPS analysis are presented in FIGS. 23. As can be seen from the XPS spectra for the LDPE sample, where the F1s peak was observed at around 692 eV, the O1s peak at 534 eV, and the C1s peak appeared at around 287 eV. Upon comparing the spectra of FIG. 23(a), the untreated and FIG. 23(b) which is the CF₄ plasma treated sample, a drastic decrease in the intensity of the C1s and O1s peaks can be observed coupled with a spike in the F1s peak. The reason for the increase in the intensity of the F1s peak and decrease in the intensity of the C1s and O1s peaks is that the CF₄ plasma treatment breaks the C-H bonds, forming new fluorine containing bonds. This increase of the fluorine amount also correlates with the observations made for the CA measurements. The air and oxygen treated samples in FIGS. 23(c) and (d)demonstrate higher C1s and O1s peaks, which can be attributed to the introduction of oxygen bearing functional during the treatment onto the surface.

Similar results can be observed for the XPS spectra of silicone as demonstrated in FIGS. 23(e), (f), (g), and (h) for untreated, plasma gas treatment of CF₄, O₂, and air, respectively. It is apparent that the F1s peak rises sharply after the CF₄ plasma treatment. However, less increase is observed after the oxygen and air plasma treatment, since only the O1s peak rises in intensity. These results prove the functionalization after treatment with fluorine and oxygen containing functional groups onto the surface of the samples.

### 3.8 Multiple Succeeding Plasma Gas Treatments

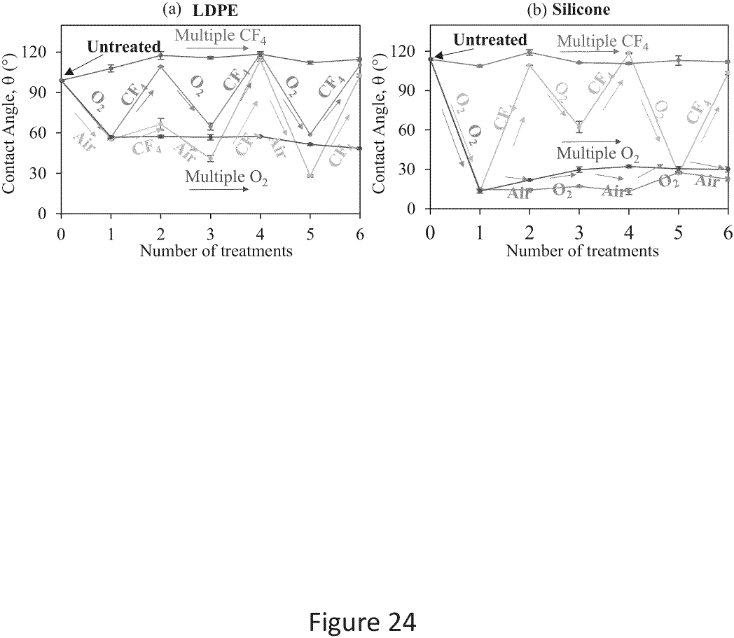

To increase the effectiveness of the plasma gas treatment and demonstrate the versatility of the method, the multiple consecutive treatments of LDPE and silicone were studied with different gases. By applying consecutive different plasma gases, different functional groups are generated on the surface of the materials by breaking/replacing the original bonds. These newly created functional groups then interact during the second treatment with the other plasma gas. To the authors’ best knowledge, using a second plasma gas treatment to increase the effectiveness of the overall wettability results in this way has yet to be studied. This is based on the fact that the function groups from the previous runs will interact differently with the newly introduced gas plasma and cause more dramatic changes in the wettability. The results are demonstrated in FIGS. 24, where the best combinations for LDPE and the silicone samples are illustrated. The first treatment was done with the previously determined preferred parameters, the following treatments were run at the preferred process power for an irradiation time of 2 minutes to not risk losing the initial functionalization due to etching. For comparison, CF₄ and O₂ plasma gas treatment were run in succession, wherein the first run was done with the predetermined preferred parameters and the following runs with preferred plasma power for an irradiation time of 2 minutes.

As seen in FIGS. 24, a consecutive treatment with air followed by CF₄ and O₂ followed by CF₄ plasma gas proved to be the most effective configuration for the treatment of LDPE. The lowest contact angle with almost 25° was achieved with the treatment configuration of air and CF₄, such a low CA was not achievable with any other configuration or treatment for LDPE. Additionally, the combination of air and CF₄ plasma seems to have a trend, leading to lower contact angles with increasing number of treatments. Similarly, the combination of O₂ and CF₄ plasma gas seems to demonstrate a trend of increasing contact angle with the number of treatments. However, it started to yield a slightly lower CA value at the sixth treatment.

For silicone, the highest and lowest CA values were observed for the combination of O₂ and CF₄, and O₂ and air plasma gas. The latter seems to increase in contact angle after each O₂ plasma gas treatment and decrease with air plasma gas, whereas decreases with O₂ plasma gas and increases with CF₄ plasma gas. It seems that the treatment for silicone yields less drastic results compared to the LDPE counterpart, which is due to the stronger bond energies. However, with increasing number of treatments, a sharper change in wettability might occur.

### 4. Conclusions

Plasma process parameters were optimized for the two polymeric materials, LDPE and silicone to determine the preferred wetting properties. It was found that the preferred plasma treatment for low-density polyethylene takes place at an irradiation time of 15 minutes, 2 minutes, and 10 minutes at a plasma power of 90 W, 150 W, and 30 W for CF₄, air, and O₂ gas, respectively. For the silicone, the preferred results at 2 minutes, 5 minutes, and 10 minutes exposure time and 250 W, 150 W, and 60 W process power for CF₄, air, and O₂ gas respectively. Almost all treated materials remained relatively stable in regard to wettability at varying pH, NaCl and BSA concentrations, only the O₂ and air plasma gas treated silicone samples showed little unstable behavior at a pH of 7 and higher BSA concentrations. The stability of the modification was studied by storing the treated samples in different environments such as air, DI water, and under a slight vacuum in a desiccant. The storage in DI water allowed the silicone samples to retain their hydrophilic modification for relatively longer, increasing the duration of the initial hydrophilic change caused by the treatment by almost 8 times, then it starts to decay slowly over time. Nevertheless, the storage in water leaves the silicone samples with a SFE increase of almost 35 mN/m, whereas after 168 hours of storage in ambient air or the desiccant, the increased SFE value is only 15 mN/m. Compared to silicone the stability of the modification of the LDPE samples seems to be relatively stable, leaving a change in SFE of ±15 mN/m. The etching caused by the CF₄ and O₂ plasma treatment plasma treatments showed that for both LDPE and silicone samples resulted in the highest degree with the air treatment having the lowest surface roughness. Together with the CAH results, it seems like thicker coating can be more easily achieved by pretreated the polymeric substrate with CF₄ plasma, and thinner coating with O₂ or preferably air plasma. Lastly, the consecutive treatment of the materials with multiple plasma gases was revealed very low CA values for PE, which were not possible by using the preferred parameters, suggesting wide range of possible biomedical application upon modification including implant, blood contacting application and in vivo device application. The silicone sample also provided rather intriguing results upon succeeding plasma treatment indicating the need of further research for such a setup with multiple consecutive different plasma gas treatments e.g., CO₂ and H₂ for different surface properties.

### References for Example 2

1. Arpagaus C, Oberbossel G, Rudolf von Rohr P (2018) Plasma treatment of polymer powders - from laboratory research to industrial application. Plasma Processes and Polymers 15:1800133. https://doi.org/10.1002/ppap.201800133
2. Papakonstantinou D, Amanatides E, Mataras D, et al (2007) Improved Surface Energy Analysis for Plasma Treated PET Films. Plasma Processes and Polymers 4:S1057-S1062. https://doi.org/10.1002/ppap.200732405
3. Grace JM, Gerenser LJ (2003) Plasma Treatment of Polymers. J Dispers Sci Technol 24:305-341. https://doi.org/10.1081/DIS-120021793
4. Bassas-Galia M, Follonier S, Pusnik M, Zinn M (2017) Natural polymers. In: Bioresorbable Polymers for Biomedical Applications. Elsevier, pp 31-64
5. Mao C, Liang C, Luo W, et al (2009) Preparation of lotus-leaf-like polystyrene micro- and nanostructure films and its blood compatibility. J Mater Chem 19:9025. https://doi.org/10.1039/b912314h
6. ID I (2017) Applications of Polymers in the Biomedical Field. Curr Trends Biomed Eng Biosci 4:. https://doi.org/10.19080/CTBEB.2017.04.555650
7. Hladik J, Spatenka P, Aubrecht L, Pichal J (2006) New method of microwave plasma treatment of HDPE powders. Czechoslovak Journal of Physics 56:B1120-B1125. https://doi.org/10.1007/s10582-006-0337-6
8. Patra N, Hladik J, Pavlatová M, et al (2013) Investigation of plasma-induced thermal, structural and wettability changes on low density polyethylene powder. Polym Degrad Stab 98:1489-1494. https://doi.org/10.1016/j.polymdegradstab.2013.04.014
9. Samieyan E, Rahimi H, Ershad Langroudi A (2013) Carbon fibre reinforced polypropylene composites with plasma treated constituent materials. Plastics, Rubber and Composites 42:256-263. https://doi.org/10.1179/1743289812Y.0000000046
10. Vojtech Novácek, Petr Špatenka, Tatana Vacková, et al (2020) Enhanced interfacial strength of plasma treated polyethylene and glass. Instant Journal of Mechanical Engineering 01-08. https://doi.org/10.36811/ijme.2020.110003
11. Levchenko I, Xu S, Baranov O, et al (2021) Plasma and Polymers: Recent Progress and Trends. Molecules 26:4091. https://doi.org/10.3390/molecules26134091
12. Anand M, Cohen RE, Baddour RF (1981) Surface modification of low density polyethylene in a fluorine gas plasma. Polymer (Guildf) 22:361-371. https://doi.org/10.1016/0032-3861(81)90048-3
13. Yan YH, Chan-Park MB, Yue CY (2005) CF4 Plasma Treatment of Poly(dimethylsiloxane): Effect of Fillers and Its Application to High-Aspect-Ratio UV Embossing. Langmuir 21:8905-8912. https://doi.org/10.1021/la051580m
14. Gao S, Zhou K, Wen L (2009) Improvement of surface hydrophobicity on silicone rubber modified by CF4 radio frequency capacitively coupled plasma. Journal of Central South University of Technology 16:365-370. https://doi.org/10.1007/s11771-009-0062-y
15. Owens DK, Wendt RC (1969) Estimation of the surface free energy of polymers. J Appl Polym Sci 13:1741-1747. https://doi.org/10.1002/app.1969.070130815
16. Mullapudi RS, Sudhakar Reddy K (2020) Relationship between Rheological Properties of RAP Binders and Cohesive Surface Free Energy. Journal of Materials in Civil Engineering 32:. https://doi.org/10.1061/(ASCE)MT.1943-5533.0003199
17. Jańczuk B, Biatopiotrowicz T, Zdziennicka A (1999) Some Remarks on the Components of the Liquid Surface Free Energy. J Colloid Interface Sci 211:96-103. https://doi.org/10.1006/jcis.1998.5990
18. van Oss CJ (2006) Interfacial Forces in Aqueous Media. CRC Press
19. Tsuchida M, Osawa Z (1994) Effect of ageing atmospheres on the changes in surface free energies of oxygen plasma-treated polyethylene films. Colloid Polym Sci 272:770-776. https://doi.org/10.1007/BF00652417
20. Morra M, Occhiello E, Marola R, et al (1990) On the aging of oxygen plasma-treated polydimethylsiloxane surfaces. J Colloid Interface Sci 137:11-24. https://doi.org/10.1016/0021-9797(90)90038-P
21. Murakami T, Kuroda S, Osawa Z (1998) Dynamics of Polymeric Solid Surfaces Treated with Oxygen Plasma: Effect of Aging Media after Plasma Treatment. J Colloid Interface Sci 202:37-44. https://doi.org/10.1006/jcis.1997.5386
22. Gomathi N, Mishra I, Varma S, Neogi S (2015) Surface modification of poly(dimethylsiloxane) through oxygen and nitrogen plasma treatment to improve its characteristics towards biomedical applications. Surf Topogr 3:035005. https://doi.org/10.1088/2051-672X/3/3/035005
23. Homma H, Kuroyagi T, Izumi K, et al (1999) Diffusion of low molecular weight siloxane from bulk to surface. IEEE Transactions on Dielectrics and Electrical Insulation 6:370-375. https://doi.org/10.1109/94.775625
24. Kuchin I, Starov V (2015) Hysteresis of Contact Angle of Sessile Droplets. Math Model Nat Phenom 10:61-75. https://doi.org/10.1051/mmnp/201510403
25. Juárez-Moreno JA, Ávila-Ortega A, Oliva AI, et al (2015) Effect of wettability and surface roughness on the adhesion properties of collagen on PDMS films treated by capacitively coupled oxygen plasma. Appl Surf Sci 349:763-773. https://doi.org/10.1016/j.apsusc.2015.05.063
26. Gomathi N, Sureshkumar A, Neogi S (2008) RF plasma-treated polymers for biomedical applications
27. Salih SI, Oleiwi JK, Ali HM (2018) Study the Mechanical Properties of Polymeric Blends (SR/PMMA) Using for Maxillofacial Prosthesis Application. IOP Conf Ser Mater Sci Eng 454:012086. https://doi.org/10.1088/1757-899X/454/1/012086
28. Gao S-H, Zhou K-S, Lei M-K, Wen L-S (2008) Surface Modification of Silicone Rubber by CF4 Radio Frequency Plasma Immersion. Plasma Chemistry and Plasma Processing 28:715-728. https://doi.org/10.1007/s11090-008-9156-9
29. Shi L-S, Wang L-Y, Wang Y-N (2006) The investigation of argon plasma surface modification to polyethylene: Quantitative ATR-FTIR spectroscopic analysis. Eur Polym J 42:1625-1633. https://doi.org/10.1016/j.eurpolymj.2006.01.007
30. Sanchis MR, Blanes V, Blanes M, et al (2006) Surface modification of low density polyethylene (LDPE) film by low pressure O2 plasma treatment. Eur Polym J 42:1558-1568. https://doi.org/10.1016/j.eurpolymj.2006.02.001
31. de Geyter N, Morent R, Leys C (2008) Surface characterization of plasma-modified polyethylene by contact angle experiments and ATR-FTIR spectroscopy. Surface and Interface Analysis 40:608-611. https://doi.org/10.1002/sia.2611
The citation of any document is not to be construed as an admission that it is prior art with respect to the present invention.

Thus the invention provides surface modification of a polymeric material by plasma treatment. More specifically, this invention relates to polymer surface modification by plasma treatment using air, oxygen or CF₄ gas.

Although the invention has been described in considerable detail with reference to certain embodiments, one skilled in the art will appreciate that the present invention can be practiced by other than the described embodiments, which have been presented for purposes of illustration and not of limitation. Therefore, the scope of the appended claims should not be limited to the description of the embodiments contained herein.

What is claimed is:

1. An article comprising:
a substrate having a surface including (i) a matrix of a polymeric material having a first surface functionality, and (ii) at least one plasma-treated surface region comprising a portion of the surface,
wherein each surface region comprises a second surface functionality, and
wherein the first surface functionality and the second surface functionality are different.

2. The article of claim 1 wherein:
the surface includes a plurality of plasma-treated spaced apart surface regions.

3. The article of claim 1 wherein:
the polymeric material is selected is selected from the group consisting of polyalkylenes, polysiloxanes, acrylates, polycarbonates, polyvinyl halides, fluoropolymers, and mixtures thereof.

4. The article of claim 1 wherein:
the polymeric material is selected is selected from the group consisting of polyethylene, polydimethylsiloxane, polymethylmethacrylate, polycarbonate, polyvinyl chloride, and polytetrafluoroethylene.

5. The article of claim 1 wherein:
the surface has a contact angle of less than 60°.

6. The article of claim 1 wherein:
the surface has a sliding angle in a range of 30° to 120°, and
the sliding angle is an angle at which a water droplet moves from an initial position on the surface under the force of gravity.

7. The article of claim 1 wherein:
the surface has a surface free energy in a range of 10 mN/m to 65 mN/m as measured by the Owens-Wendt-Rabel and Kaelble method.

8. The article of claim 7 wherein:
the surface free energy remains within +/- 25% original value for at least three days when the article is immersed in a media selected from the group consisting of air, vacuum, or water.

9. The article of claim 1 wherein:
the surface has a surface roughness in a range of 16 nm - 34 nm as measured by measuring an average of surface heights and depths across the surface.

10. The article of claim 1 wherein:
each surface region has a shape selected from polygons, circles, ellipses, and ovals, and
each surface region has a largest dimension in a range of 1 micrometer to 10 millimeters.

11. The article of claim 1 wherein:
the surface includes a plurality of plasma-treated spaced apart surface regions arranged in a symmetric array.

12. The article of claim 1 wherein:
the first surface functionality comprises at least one functional group selected from the group consisting of hydroxyl, carboxylic acid, carboxylate, peroxide, epoxide, oxide, carbonyl, ketone, ether, or ester, and
the second surface functionality comprises at least one functional group selected from the group consisting of fluoride or fluorocarbon.

13. The article of claim 1 wherein:
the first surface functionality comprises hydroxyl or carboxylic acid, and
the second surface functionality comprises fluoride.

14. The article of claim 1 wherein:
the polymeric material is optically transparent.

15. A medical device comprising:
the article of claim 1.

16. A method for forming an article, the method comprising:
(a) providing a substrate having a surface including a polymeric material;
(b) contacting the surface with a first plasma to create at least one plasma-treated surface region comprising a portion of the surface, each plasma-treated surface region having a first surface functionality; and
(c) contacting each plasma-treated surface region with a second plasma to create a second surface functionality.

17. The method of claim 16 wherein:
the first plasma comprises at least one of air or oxygen, and
the second plasma comprises a fluorocarbon.

18. The method of claim 16 wherein:
the first plasma comprises at least one of air or oxygen, and
the second plasma comprises the other of the air or oxygen.

19. The method of claim 16 wherein:
steps (b) and (c) are repeated a plurality of times.

20. The method of claim 16 wherein:
steps (b) and (c) are repeated a plurality of times,
in step (b), the first plasma comprises at least one of air or oxygen, and
in step (c), the second plasma comprises a fluorocarbon, and
in a first repetition of step (b), the first plasma comprises air.

21. The method of claim 16 wherein:
steps (b) and (c) are repeated a plurality of times,
the first plasma comprises air, and
the second plasma comprises a fluorocarbon.

22. The method of claim 16 wherein:
the first surface functionality comprises at least one functional group selected from the group consisting of hydroxyl, carboxylic acid, carboxylate, peroxide, epoxide, oxide, carbonyl, ketone, ether, or ester, and
the second surface functionality comprises at least one functional group selected from the group consisting of fluoride or fluorocarbon.

23. The method of claim 16 wherein:
step (b) further comprises masking the surface of the substrate to define a perimeter of each surface region before contacting the surface with the first plasma.

24. The method of claim 16 wherein:
the polymeric material is optically transparent.
